(19) United States
(12) Patent Application Publication
(10) Pub. No.: US 2024/0308603 A1
(43) Pub. Date: Sep. 19, 2024

(54) Tracked Vehicle, Running Rail Arrangement, Vehicle System and Method for Traveling on a Running Rail Arrangement

(71) Applicant: Magnecat UG (HAFTUNGSBESCHRÄNKT), Bayreuth (DE)

(72) Inventor: Achim Keppner, Bayreuth (DE)

(73) Assignee: MagneCat UG (HAFTUNGSBESCHRÄNKT), Bayreuth (DE)

(21) Appl. No.: 17/757,188

(22) PCT Filed: Jan. 15, 2021
(86) PCT No.: PCT/EP2021/050782

§ 371 Date: Jun. 10, 2022

(30) Foreign Application Priority Data
Jan. 17, 2020 (DE) 102020101114.8

(51) Int. Cl. B62D 55/084; B62D 11/02; B62D 55/06

(52) U.S. Cl. CPC B62D 55/084; B62D 11/02; B62D 55/06

(57) ABSTRACT

A tracked vehicle includes a load assembly, at least two drive tracks movably mounted thereon to move along a circulation path of respective drive tracks. The drive tracks are formed on respective caterpillar assemblies. Tilting means tilt the caterpillar assemblies about respective inclination axes that extend parallel to a vehicle width direction. Shifting means shift the caterpillar assemblies along the axis between retracted and extended positions, the former being below an underbody of the load assembly and the latter protruding the caterpillar assemblies beyond the load assembly on opposite sides in the vehicle width direction. A running rail arrangement for the tracked vehicle is also included. A vehicle system includes the tracked vehicle and the running rail arrangement. Also included is a method for traveling on the running rail arrangement by the tracked vehicle.

### CROSS-REFERENCE TO RELATED APPLICATIONS

This application claims the priority, under 35 U.S.C. §§ 119, 120, 172, 363, 365, and 371, of German patent application No. 10 2020 101 114.8, filed Jan. 17, 2020, and International Application No. PCT/EP2021/050782, filed Jan. 15, 2021, which designated the United States and was/was not published in English; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present invention relates to a tracked vehicle and a running rail arrangement for such a tracked vehicle. The invention also relates to a vehicle system which includes the tracked vehicle and the running rail arrangement. Furthermore, the invention relates to a method for traveling on the running rail arrangement by means of the tracked vehicle.

### BACKGROUND OF THE INVENTION

DE20 2020 100 256 U1 discloses a caterpillar vehicle of this type which comprises a load assembly and at least two drive caterpillars which are movably mounted on the load assembly for movement along an orbit of the respective drive caterpillar for travel of the caterpillar vehicle along one running direction. A vehicle system is also known from this, which comprises the crawler vehicle of the generic type and a roadway arrangement of the generic type. In this case, the tracked vehicle can comprise two or more pairs of drive tracks which are arranged via holding platforms on the load assembly of the tracked vehicle. The holding platforms can be rotated about rotation axes which extend perpendicularly to a direction in which the tracked vehicle stands. This allows the tracked vehicle to turn in any direction in the horizontal plane.

However, the freedom of movement of the tracked vehicle of this type is limited for various reasons. The drive tracks and support platforms can align within a horizontal plane (e.g., on a level surface such as a road) merely by rotation about their rotation axis. When driving on a non-level surface (e.g. a road with an incline), the drive tracks cannot be adjusted in such a way that a tilting of the load assembly can be compensated. The load assembly thus inclines to the same extent as the incline of the level to be traveled on. Since, for example, the goods located in the load assembly can shift unintentionally or people can fall in the load assembly due to inclinations of the load assembly, the tracked vehicle of the generic type is therefore limited to substantially horizontal roadways.

### SUMMARY OF THE INVENTION

It is therefore an object of the present invention to further develop a generic tracked vehicle such that the degrees of freedom of movement and the agility of the tracked vehicle are increased and at the same time the tracked vehicle is prevented from tilting excessively.

According to the invention, this object is achieved in a generic tracked vehicle in that each drive track is formed on a respective caterpillar assembly and the crawler vehicle also has tilting means for tilting the caterpillar assemblies about a respective inclination axis, which extends substantially perpendicularly to a movement direction of the respective drive track, and shifting means for shifting the caterpillar assemblies along the respective inclination axis between a stowed position and an extended position, wherein the caterpillar assemblies are located below an underbody of the load assembly in the stowed position, and wherein the caterpillar assemblies in the extended position project beyond the load assembly on opposite sides in the vehicle width direction.

The tilting means thus allow the caterpillar assemblies to rotate about their inclination axis, which extends substantially perpendicularly to a movement direction of the drive tracks. By tilting the caterpillar assemblies, their orientation relative to the load assembly and relative to a roadway on which the tracked vehicle is standing or traveling can be changed without tilting the load assembly. Also, the load assembly can be raised by the inclination of the caterpillar assemblies, whereby the ground clearance can be increased when driving in rough terrain. Generally, in the stowed position, the caterpillar assemblies are below the underbody of the load assembly. The caterpillar assemblies do not protrude laterally from the load assembly, but are covered by the load assembly when viewed from above the tracked vehicle. Therefore, when the caterpillar assemblies are in the stowed position, less space is required for the movement of the tracked vehicle. However, the shifting means allow the caterpillar assemblies to be shifted in translation along their inclination axes, even into the extended position. In the extended position, the caterpillar assemblies are not covered by the underbody of the load assembly from above and can therefore tilt 360° about their inclination axes without colliding with the load assembly. On the one hand, the tracked vehicle according to the invention can thereby perform horizontal travel along a horizontal roadway or horizontally arranged rails. On the other hand, the tracked vehicle according to the invention can also be used to carry out inclined travel with any gradient along a sloping roadway or on sloping running rails, with the load assembly not tilting. Thus, a safe transport of the goods or people inside can be guaranteed.

In principle, it is conceivable that the tracked vehicle according to the invention moves exclusively in a straight line along horizontal or inclined roadways and/or rails. However, the tracked vehicle according to the invention expediently also includes steering means for changing the running direction of the tracked vehicle.

The steering means enable the tracked vehicle not only to move in a straight line, but also to change its running direction on a roadway. The tracked vehicle can thus move flexibly on a roadway and carry out various driving maneuvers or drive trajectories.

According to one embodiment of the present invention, the steering means are designed to change the running direction of the tracked vehicle by means of different rotational speeds and/or directions of rotation of the drive tracks.

The running direction of the tracked vehicle according to the invention can thus be changed, similar to a tank, for example, in that the drive tracks are moved with different directions of rotation and/or rotational speeds. Compared to conventional vehicle steering systems, such as in passenger car (car) steering systems, in which only the two front wheels can be steered and each can only be deflected equally, the turning circle of the tracked vehicle can be reduced, which in particular increases the agility of the tracked vehicle.

In a further embodiment of the present invention, the steering means are designed to change the running direction of the tracked vehicle by rotating the caterpillar assemblies about associated steering axes.

Through the individual rotation of the individual caterpillar assemblies around their steering axles, their respective track angles can be flexibly changed. With a corresponding alignment of the individual caterpillar assemblies relative to one another, the turning circle of the tracked vehicle can be reduced when cornering. This also makes it possible to carry out new driving maneuvers or to drive trajectories that cannot be carried out with conventional vehicles. Thus, when the load assembly is stationary, the caterpillar vehicle can rotate the caterpillar assemblies by 90° about their steering axes in order to carry out a transverse journey, with the alignment of the load assembly in the plane not being changed in the process.

In the retracted position, the caterpillar assemblies can be pierced by their respective steering axis in a front end area or in a rear end area.

In steering the caterpillar assemblies, the caterpillar assemblies rotate relative to the roadway about a pivot located within a contact surface formed in a contact area between each drive track and the roadway. When the caterpillar assemblies are tilted about their respective inclination axis in the stowed position, the position of the contact surface on the drive tracks changes toward a front end portion or a rear end portion of the caterpillar assemblies. If the steering axles pierce the respective caterpillar assembly in this front or rear end region, the load assembly can be prevented from undesirably moving in a gyroscope-like manner when the caterpillar assemblies are steered.

According to a further embodiment of the invention, the caterpillar assemblies are pierced by their respective inclination axis in a front end area or in a rear end area.

By arranging the inclination axes in a front or rear end area of the caterpillar assemblies, it is possible for the caterpillar assemblies to stand on a tip during a rotation about their inclination axes and thereby lift the load assembly vertically. The tip is that end area of the caterpillar ship that is not penetrated by its inclination axis. In the retracted position of the caterpillar assemblies, this can prevent the crawler ships from colliding with the underbody of the load assembly when tilting. In addition, this arrangement of the inclination axes allows the caterpillar assemblies to be inclined in the retracted position and in the extended position by a certain angle in a rotation direction in which the load assembly does not rise or rises only minimally.

In a preferred embodiment of the present invention, the respective steering axis of each caterpillar assembly intersects its respective inclination axis.

When the steering axes of the caterpillar assemblies intersect their respective inclination axes, the caterpillar assemblies can be tilted such that the contact surface of the respective drive track is at an end portion of the caterpillar assembly penetrated by the respective steering axis and inclination axis. The steering axis, inclination axis and footprint of the drive tracks are all on the same end portion of the caterpillar assembly in this configuration. As a result, when the caterpillar assemblies are steered and/or tilted, a direct and straight flow of force between the caterpillar vehicle and the roadway can be ensured and no undesirable bending moments occur.

In a further embodiment of the invention, the tracked vehicle further comprises clamping means for shifting at least two caterpillar assemblies arranged side by side in the vehicle width direction along respective clamping axes extending substantially in a vehicle longitudinal direction.

In order for the tracked vehicle to be able to move along vertically running rail arrangements, it is necessary for the tracked vehicle to be clamped to the rails. With the aid of the clamping means, the caterpillar assemblies can be shifted relative to one another along their clamping axes and generate a clamping force in interaction with the vertically arranged running rails. The clamping force prevents the caterpillar assemblies from slipping off the rails when driving on vertically arranged rails. The tracked vehicle is thus clamped to the vertical running rail arrangement and it is possible to drive on the tracked vehicle in the vertical direction.

According to the invention, a running rail arrangement is also proposed, which comprises at least two running rails, which are arranged substantially parallel to one another, each of the running rails having a structure with projections and depressions, which is designed to engage in a form-fitting and/or force-fitting manner with drive tracks of a tracked vehicle according to the invention to be.

The running rails can be arranged in any direction in space and form a predetermined trajectory along which the tracked vehicle can travel. It is possible to arrange the running rails at any location, largely independent of the environmental conditions, e.g. on or in buildings, over ravines, on steep slopes, etc. The possible routes for the tracked vehicle can thus be designed flexibly. When driving on the rails, the drive tracks are in form-fitting and/or force-fitting engagement with their structure, which ensures that the tracked vehicle can move safely on the running rail arrangement and does not slip off it.

The structure is preferably provided in the form of a structured surface of a solid running rail.

The structured surfaces of the respective running rails are designed to contact the drive tracks of the tracked vehicle, thus enabling a firm engagement. In particular, when the running rails are not arranged horizontally but at a steep angle, the structured surfaces on the running rails can prevent the drive tracks of the tracked vehicle from losing engagement with the running rails and thereby slipping off. The safety of the tracked vehicle when driving on the running rails can thus be increased.

The running rail arrangement according to the invention can also include at least one oblique running module, the oblique running module comprising at least two running rails, which are designed to be attached to a surrounding support structure in such a way that they run parallel to one another and at an angle from a lower runway to a first upper runway, wherein the first upper runway is at a predetermined height relative to the lower runway, and wherein the two running rails are horizontally spaced from each other by a distance substantially equal to the distance of the caterpillar assemblies in the extended position in the vehicle width direction, and wherein the oblique running module comprises at least two curved transition elements, each transition element being arranged at an upper end region of a respective running rail and being designed to connect the respective running rail to the first upper runway.

The tracked vehicle can move along the oblique running module in the third dimension and move between two runways that are located at different heights. The oblique running module includes two rails and is therefore suitable for being driven on by caterpillar vehicles with two caterpillar assemblies. In order to drive on the oblique running module, the caterpillar assemblies are in the extended position and are inclined about their inclination axes in such a way that the drive tracks are positioned substantially parallel to the travel rails. At this time, since the caterpillar assemblies are in the extended position and the running rails are horizontally spaced from each other by the same distance as the caterpillar assemblies in the extended position in the vehicle width direction, the load assembly can be kept in a horizontal orientation between the running rail arrangement and tilts not when running the rail assembly. The transition elements form curved connecting elements between the rails of the oblique running module and the first upper runway and thus enable a transition of the tracked vehicle between the oblique running module and the first upper runway. Due to the curved shape of the transition elements, the caterpillar assemblies do not have to overcome any edges or the like when transitioning between the rails of the oblique running module and the first upper runway.

According to a further embodiment of the invention, the running rail arrangement comprises a first oblique running module and a second oblique running module, which are arranged relative to one another in such a way that they each run obliquely from the lower runway to the first upper runway, the rails of the first oblique running module and the second oblique running module being substantially parallel to each other, and wherein the first oblique running module and the second oblique running module are horizontally spaced by a distance substantially equal to a distance of the inclination axes of the caterpillar assemblies in a straight running position in the vehicle front-rear direction.

Since the running rail arrangement comprises a first oblique running module and a second oblique running module and thus four running rails, it can be driven on both by tracked vehicles with two caterpillar assemblies and by tracked vehicles with four caterpillar assemblies. In the embodiment in which the tracked vehicle comprises four caterpillar assemblies, the drive tracks of all four caterpillar assemblies are each in contact with a corresponding running rail. Also in this embodiment, the distance between the running rails of an oblique running module corresponds to the distance of the caterpillar assemblies in the extended position in the vehicle width direction and is larger than the width of the load assembly. The load assembly of the tracked vehicle can therefore be accommodated between the running rails while driving on the running rail arrangement. Moreover, in this embodiment, the distance between the first inclined traveling module and the second inclined traveling module corresponds to the distance of the inclination axes of the caterpillar assemblies, which are in the straight traveling position, in the vehicle front-rear direction. Therefore, the running rail arrangement can be driven on in such a way that only the caterpillar assemblies are inclined parallel to the running rails in the extended position and the load assembly is horizontally aligned and not inclined.

In principle, the running rail arrangement can be designed to connect a lower runway with only a first upper runway. According to the invention, however, it is also possible for a plurality of oblique running modules to be arranged one above the other to connect the lower runway to the first upper runway and the first upper runway to a second upper runway arranged above it in such a way that their rails are aligned in pairs and that passage openings between the oblique running modules arranged one above the other are provided, which are dimensioned in such a way that it is possible for the caterpillar assemblies to switch between an oblique running position and a horizontal running position for driving into or out of the running rail arrangement, and that the caterpillar assemblies are in the inclined position when crossing the passage openings and continuously in contact with at least one oblique running module.

With the plurality of oblique running modules arranged one above the other, several runways that are located at different heights can be connected to one another. The tracked vehicle can thus travel flexibly on runways at different heights, as a result of which different driving maneuvers or trajectories can be driven with the tracked vehicle. The caterpillar assemblies can cross the passage openings when driving on the running rail arrangement and continue the inclined travel by remaining in the inclined position when they reach the passage openings. The passage openings are dimensioned in such a way that each drive track is in uninterrupted contact with at least one of the rails arranged one above the other when crossing it. As a result, continuous engagement between the caterpillar assemblies and the running rails can be ensured when crossing the passage openings, and the tracked vehicle can be prevented from slipping off. However, the passage openings also allow the tracked vehicle to be able to drive out of the running rail arrangement onto a runway or from a runway onto the running rail arrangement. When they reach the passage opening, the caterpillar assemblies switch between the horizontal running position and the oblique running position, as a result of which the inclined travel can be started or ended.

According to a further embodiment of the invention, the running rail arrangement comprises at least one vertical running module, the vertical running module comprising a first pair of running rails and a second pair of running rails which are arranged parallel to one another and are designed to engage in a form-fitting and/or force-fitting manner with drive tracks of a tracked vehicle according to the invention and to be attached to a surrounding support structure such that they extend vertically from a lower runway to a first upper runway, the first upper runway being at a predetermined elevation relative to the lower runway, and wherein the vertical running module has at least two transition elements adapted to be skewed on the first upper runway at the predetermined height adjacent upper end regions of the running rails such that the structure of each transition element is opposite of a structure of a corresponding running rail, wherein the running rails of each pair of running rails are spaced from each other by a distance substantially equal to the distance of the caterpillar assemblies in the extended position in the vehicle width direction, and wherein the first pair of running rails is spaced from the second pair of running rails by a distance which corresponds substantially to the distance of the inclination axes of the caterpillar assemblies in the straight running position in the vehicle longitudinal direction.

Along the vertical running module, the tracked vehicle can move in a vertical direction in the third dimension and move between two runways located at different heights. Since the running rail arrangement comprises a first pair of running rails and a second pair of running rails, it can in particular be driven on by tracked vehicles with four caterpillar assemblies. In order to drive on the vertical running module, the caterpillar assemblies are in the extended position and are inclined in such a way that each drive track is in a form-fitting and/or force-fitting engagement with a corresponding running rail. The load assembly can therefore be accommodated in a horizontal alignment between the rails when driving on the running rail arrangement and does not tilt in the process. Due to the vertical arrangement of the first and second pairs of running rails, the running rail arrangement saves space and can be used in various locations, such as on or in buildings, storage racks, mountains, construction sites, etc. When used inside a building, the running rail arrangement can function together with the tracked vehicle as a kind of elevator. The vertical running module comprises at least two transition elements, which are not formed integrally with the running rails, but are provided opposite to the upper end regions of the running rails on the first upper runway. These allow the tracked vehicle to transition between the vertical running module and the first upper runway.

According to one embodiment, the structure can be arranged on each of the running rails in such a way that when the caterpillar assemblies are moved in the direction of the structure in a vertical running position by means of the clamping means, a clamping force or tension force is generated between the caterpillar assemblies and the running rails in the horizontal direction.

To drive on the vertical running module, the caterpillar assemblies are in the vertical running position, in which the caterpillar assemblies are inclined by 90° relative to the horizontal running position about their inclination axis. In this position, a sufficiently high clamping force or tension force must act between the caterpillar assemblies and the running rail arrangement so that the caterpillar assembly does not slip off the rails. In the vertical running position, the caterpillar assemblies can be moved in the direction of the structure with the aid of the clamping means, as a result of which a clamping force or tension force is generated between the caterpillar assemblies and running rails. This clamping force or tension force provides the necessary holding force that is necessary for the tracked vehicle to be able to drive safely on the vertical running module without slipping.

In principle, the running rail arrangement can be designed to connect a lower runway with only a first upper runway. However, it is also possible for a plurality of vertical running modules to be arranged one above the other to connect the lower runway to the first upper runway and the first upper runway to a second upper runway arranged above it in such a way that their running rails are aligned in pairs with one another, and passage openings between the above one another arranged vertical running modules are provided, which are dimensioned in such a way that it is possible for the caterpillar assemblies to switch between a vertical running position and a horizontal running position for entering or exiting the running rail arrangement, and that the caterpillar assemblies are continuously in contact with at least one vertical running module when crossing the passage openings in the vertical running position.

With the plurality of vertical running modules arranged one above the other, several runways that are at different heights can be connected to one another. The tracked vehicle can thus travel flexibly on runways at different heights, as a result of which different driving maneuvers or trajectories can be driven with the tracked vehicle. For example, the running rail arrangement can function on or in a building together with the tracked vehicle as a kind of elevator that connects several floors to one another. The caterpillar assemblies can cross the passage openings when driving on the running rail arrangement and continue vertical travel by remaining in the inclined vertical running position when reaching the passage openings. The passage openings are dimensioned in such a way that each drive track is in uninterrupted contact with at least one of the running rails arranged one above the other when crossing it. As a result, continuous engagement between the caterpillar assemblies and the running rails can be ensured when crossing the passage openings, and the tracked vehicle can be prevented from slipping off. However, the passage openings also allow the tracked vehicle to drive out of the running rail arrangement onto a runway or from a runway onto the running rail arrangement. Upon reaching the passage opening, the caterpillar assemblies switch between the horizontal running position and the vertical running position, as a result of which the vertical travel can be started or ended.

Furthermore, a vehicle system is proposed according to the invention, comprising a tracked vehicle according to the invention and a running rail arrangement according to the invention.

Furthermore, the invention proposes a method for driving on a running rail arrangement according to the invention with a tracked vehicle according to the invention, which comprises the following steps: Approaching of the tracked vehicle to the running rail arrangement on a lower runway or an upper runway, shifting the caterpillar assemblies along a respective inclination axis from a retracted position to a extended position, tilting the caterpillar assemblies about the respective inclination axis by a predetermined angle from a horizontal running position to an oblique running position or to a vertical running position, entering the running rail arrangement by engaging the drive tracks of the caterpillar assemblies with the structure of the respective running rails, driving on the running rail arrangement between an area of the lower runway and an area of the upper runway, engaging the drive tracks of the caterpillar assemblies with the structure of the respective transition elements, driving on the transition elements and tilting of the caterpillar assemblies around the respective inclination axis into the horizontal running position and getting out from the running rail arrangement and driving on the upper runway or the lower runway.

When carrying out the method according to the invention, the tracked vehicle initially travels on any runway and approaches the running rail arrangement. When the tracked vehicle approaches on the lower runway, the caterpillar assemblies can be in both the retracted position and the extended position. With the caterpillar assemblies in the retracted position, the tracked vehicle passes between the running rails and does not drive on the running rail arrangement. If, on the other hand, the caterpillar assemblies are shifted into the extended position when approaching the running rail arrangement, the tracked vehicle can start traveling along the running rail arrangement. When the tracked vehicle approaches the running rail arrangement on one of the upper runways, the caterpillar assemblies can again be in the retracted position or in the extended position. However, the caterpillar assemblies must be shifted to the extended position before the tracked vehicle reaches an opening in the respective runway in order to avoid the tracked vehicle falling into the opening. The tracked vehicle can also drive through the running rail arrangement on one of the upper runways if the caterpillar assemblies remain in the horizontal running position and are not tilted. A journey along the running rail arrangement can be started by tilting the caterpillar assemblies accordingly. The caterpillar assemblies that are in the extended position are tilted about their respective inclination axes to the oblique running position or the vertical running position. In the oblique running position and in the vertical running position, the caterpillar assemblies are arranged parallel to the respective running rails. During the step of moving into the running rail arrangement, this enables the most secure and firm engagement possible between the drive tracks and the running rails. The load assembly, on the other hand, remains aligned and does not tilt even when the caterpillar assemblies are tilted to the inclined or vertical running position. In the step of driving on the running rail arrangement, due to the firm engagement between the drive tracks and the running rails, safe inclined travel or vertical travel can be ensured and the drive tracks can be prevented from slipping off the running rails. When the tracked vehicle has reached the intended runway, the transition elements are traveled over and the caterpillar assemblies are tilted from the inclined or vertical running position back to the horizontal running position. The tracked vehicle then leaves the running rail arrangement and drives on the desired runway. Efficient inclined travel and/or vertical travel of the tracked vehicle according to the invention is thus possible with the method according to the invention. The method also enables the load assembly to be transported safely between several runways without the load assembly having to be tilted.

During vertical travel, the step of engaging the drive tracks of the caterpillar assemblies with the structure of the respective transition elements preferably comprises the following sub-steps: shifting at least one caterpillar assembly by means of its clamping means along the clamping axis between the structure of the respective running rail and the structure of the respective transition element, and maintaining the engagement of at least three caterpillar assemblies with one of the structures of the respective running rail or the respective transition element.

At the transition between the vertical running module and the runway, it must be ensured that the tracked vehicle cannot slip or fall within the running rail arrangement due to a loss of engagement with the running rails. Therefore, during this transition, at least one caterpillar assembly is shifted along the clamping axis between the structure of the respective running rail and the respective transition element. At all times, however, the engagement of at least three caterpillar assemblies with the structure of the respective running rail, the respective transition element or with the runway is maintained. As a result, a secure engagement between the caterpillar assemblies and the rails of the vertical running module can be guaranteed at all times and the tracked vehicle can be prevented from slipping or falling within the running rail arrangement. This improves safety when driving on the vertical running module.

After leaving the running rail arrangement, the method according to the invention preferably includes a step of relocating the caterpillar assemblies along a respective inclination axis from an extended position to a retracted position.

When the caterpillar assemblies are again shifted to the retracted position after the tracked vehicle has reached the intended runway, less space in the vehicle width direction is required for the tracked vehicle to travel on the runway. In addition, since the caterpillar assemblies are below the underbody of the load assembly in the stowed position, the likelihood of collision between the caterpillar assemblies and surrounding objects or structures can be reduced.

### BRIEF DESCRIPTION OF THE DRAWINGS

Embodiments of the invention are explained below with reference to the figures as non-limiting examples. Here is shown:

FIG. 1A is a schematic perspective view of a caterpillar assembly of a tracked vehicle according to the invention in the retracted position and in a non-tilted position.

FIG. 1B is a schematic perspective view of the caterpillar assembly of FIG. 1A in the retracted position and in a reclined position.

FIG. 1C is a schematic perspective view of the caterpillar assembly of FIG. 1A in the extended position and in a non-tilted position.

FIG. 2A shows a schematic perspective view of a caterpillar vehicle according to the invention with two caterpillar assemblies at the beginning of an inclined drive on a running rail arrangement according to the invention with oblique running modules.

FIG. 2B shows a schematic perspective view of the tracked vehicle from FIG. 2A when crossing a passage opening between two oblique running modules during inclined travel.

FIG. 3 shows a schematic side view of a running rail arrangement according to the invention, which connects several runways with oblique running modules, and various positions of the tracked vehicle when driving on the oblique running modules of the running rail arrangement.

FIG. 4 shows a schematic perspective view of a tracked vehicle according to the invention with four caterpillar assemblies and a running rail arrangement according to the invention, which connects several runways with oblique running modules to one another.

FIG. 5A shows a schematic view of the tracked vehicle according to the invention from FIG. 4 when the tracked vehicle approaches the running rail arrangement on a lower runway, viewed from behind.

FIG. 5B is a schematic view of the tracked vehicle, similar to FIG. 5A, after the caterpillar assemblies have been shifted along their inclination axes from the retracted position to the extended position.

FIG. 5C shows a schematic view of the tracked vehicle, similar to FIGS. 5A and 5B, when driving on the running rail arrangement between an area of the lower runway and an area of an upper runway.

FIG. 6A shows a schematic side view of the tracked vehicle from FIG. 4 when crossing passage openings between oblique running modules during inclined travel.

FIG. 6B shows a schematic lateral partial view of the tracked vehicle, similar to FIG. 6A, when driving over the transition elements and the tilting of the caterpillar assemblies about the respective inclination axis into the horizontal running position.

FIG. 6C shows a schematic side view of the tracked vehicle, similar to FIGS. 6A and 6B, when exiting the running rail arrangement and driving on the upper runway.

FIG. 7 shows a schematic perspective view of a tracked vehicle according to the invention with four caterpillar assemblies and a running rail arrangement according to the invention, which connects several runways with vertical running modules to one another.

FIG. 8A is a schematic side view of the tracked vehicle of FIG. 7 when tilting the caterpillar assemblies about the respective inclination axis from a horizontal running position to a vertical running position.

FIG. 8B is a schematic side view of the tracked vehicle, similar to FIG. 8A, when the drive tracks of the caterpillar assemblies are engaged with the structure of the respective running rails.

FIG. 8C shows a schematic side view of the tracked vehicle, similar to FIG. 8B, when crossing passage openings between two vertical running modules arranged one above the other during vertical travel.

FIG. 8D shows a schematic side view of the tracked vehicle, similar to FIG. 8C, when two caterpillar assemblies arranged next to one another in the vehicle width direction tilt about the respective inclination axis from a vertical running position to a horizontal running position.

FIG. 8E shows a schematic side view of the tracked vehicle, similar to FIG. 8D, when shifting at least one caterpillar assembly by means of its clamping means along the clamping axis between the structure of the respective running rail and the structure of the respective transition element.

FIG. 8F shows a schematic side view of the tracked vehicle, similar to FIG. 8E, when exiting the running rail arrangement and driving on the upper runway.

FIG. 9A is a schematic perspective view of a caterpillar assembly in the retracted position and in the non-tilted position.

FIG. 9B is a schematic perspective view of the caterpillar assembly of FIG. 9A during a combined rotation about its steering axis and pitching about its inclination axis.

FIG. 9C is a schematic perspective view of the caterpillar assembly of FIG. 9A after combined rotation about its steering axis and tilting about its inclination axis in a traverse position.

### DETAILED DESCRIPTION OF THE EMBODIMENTS

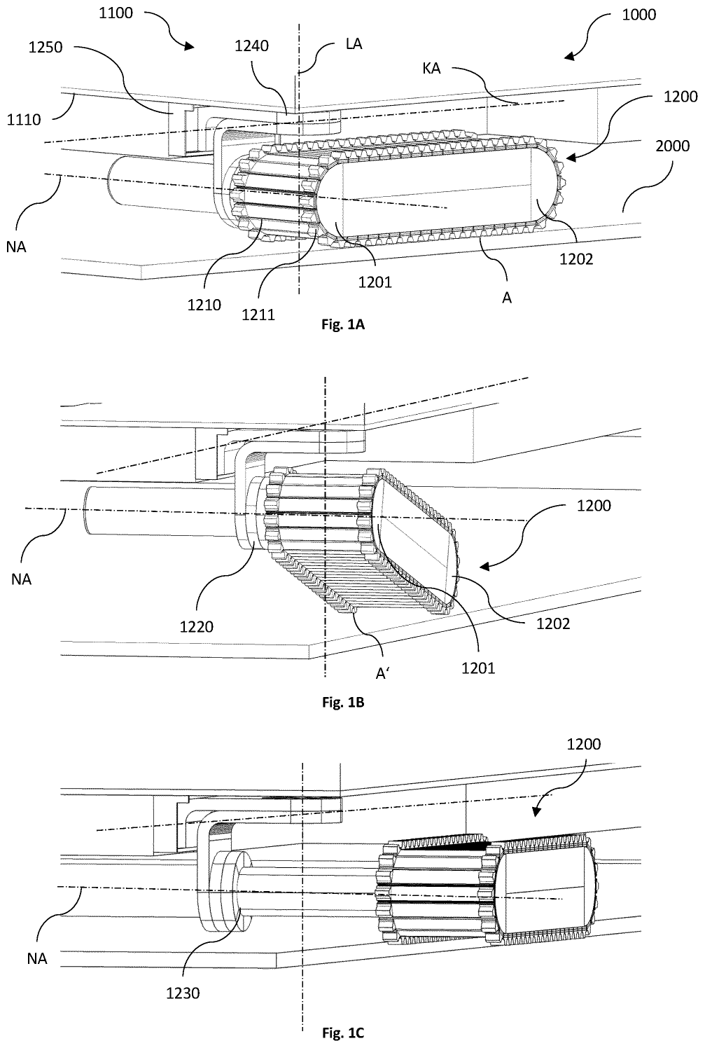

Degrees of freedom of movement of a caterpillar assembly 1200 are described below with reference to FIGS. 1A to 1C. FIG. 1A shows a schematic perspective view of a caterpillar assembly 1200 of a tracked vehicle 1000 according to the invention in the retracted position and in a non-tilted position. FIG. 1B shows a schematic perspective view of the caterpillar assembly 1200 of FIG. 1A in the retracted position and in a reclined position, and FIG. 1C shows a schematic perspective view of the caterpillar assembly 1200 of FIG. 1A in the extended position and in a non-tilted position. It should be noted that FIGS. 1A to 1C only show the detailed view of a caterpillar assembly 1200 of the tracked vehicle 1000. However, the tracked vehicle 1000 according to the present invention may include a plurality of caterpillar assemblies 1200, such as two or four caterpillar assemblies 1200. A caterpillar assembly 1200 will be described in detail below, and these explanations apply to all caterpillar assemblies 1200 of the tracked vehicle 1000.

The caterpillar assembly 1200 is arranged on an underbody 1110 of a load assembly 1100 of the tracked vehicle 1000. In the embodiment of the tracked vehicle 1000 according to the invention shown in FIGS. 1A to 1C, the caterpillar assembly 1200 has an elongated shape that is rounded off at a front end area 1201 and at a rear end area 1202. The caterpillar assembly 1200 includes a drive track 1210 which is circumferentially provided on the caterpillar assembly 1200 and is movably supported along an orbit of the caterpillar assembly 1200. The drive track 1210 stands on a footprint A on a runway 2000. In the embodiment illustrated in FIGS. 1A to 1C, the drive track 1210 is formed as a revolving chain, which comprises a number of chain links and has a structure 1211 with projections and depressions on its outer surface. This type of drive track 1210 is similar to those used, for example, in tanks or snow cats. The drive track 1210 of the caterpillar assembly 1200 can be driven with a drive unit (not shown), while moving along the orbit around the caterpillar assembly 1200 and rolling on the runway 2000 in the area of the contact surface A. Examples of the drive unit can be an electric motor, an internal combustion engine or, similar to DE20 2020 100 256 U1 already explained above, a linear motor. By driving the drive tracks 1210, the entire tracked vehicle 1000 is set in motion. It should be noted that the drive track 1210 can move along the caterpillar assembly 1200 in either rotational orientation and thus the tracked vehicle 1000 can move in different directions.

The caterpillar assembly 1200 further includes tilting means. The tilting means comprises a tilting actuator 1220 which enables rotation of the caterpillar assembly 1200 about a inclination axis NA which extends substantially perpendicularly to the rotation direction of the drive track 1210 and pierces the caterpillar assembly 1200 in the front end region 1201, as shown in FIG. 1B. Examples of the tilting actuators 1220 can be hydraulic, pneumatic and/or electric rotary actuators. As the caterpillar assembly 1200 rotates about the inclination axis NA as shown in FIG. 1B, the footprint A′ shifts toward the rear end portion 1202 of the caterpillar assembly 1200 and is smaller than the footprint A in the non-tilted position due to the elongated shape of the caterpillar assembly 1200, which is shown in FIG. 1A. Due to the smaller contact surface A′ in the inclined position of the caterpillar assembly 1200, when driving the drive track 1210 there is less friction between the drive track 1210 and the runway 2000, whereby the tracked vehicle 1000 can be propelled more efficiently. A corresponding inclination of all caterpillar assemblies 1200 of the tracked vehicle 1000 also changes the vertical distance between their inclination axes NA and the runway 2000, as a result of which the entire load assembly 1100 is lifted. By raising the load assembly 1100, for example, the ground clearance can be increased when driving over rough terrain. It is also possible to rotate the caterpillar assembly 1200 about the inclination axis NA in a counter-clockwise rotation direction, although the contact surface A′ shifts towards the front end region 1201 of the caterpillar ship 1200 and the distance between the underbody 1110 of the load assembly 1100 and the runway 2000 remains substantially unchanged.

The caterpillar assembly 1200 also includes shifting means. The shifting means includes a shifting actuator 1230 which enables shifting of the caterpillar assembly 1200 along the inclination axis NA from a retracted position as shown in FIG. 1A to an extended position as shown in FIG. 1C. Examples of the shifting actuators 1230 can be hydraulic, pneumatic and/or electric linear actuators. When the caterpillar assembly 1200 is shifted to the extended position, the caterpillar assembly 1200 is shifted beyond one side of the load assembly 1100 in the vehicle width direction when viewed from above. In the extended position, a rotation of the caterpillar assembly 1200 by 360° around the inclination axis NA is possible, since the caterpillar assembly 1200 projects laterally beyond the load assembly 1100 and cannot collide with the underbody 1110 of the load assembly 1100 during any rotation about the inclination axis NA.

The caterpillar assembly 1200 shown in FIGS. 1A to 1C also includes steering means. The steering means includes a steering actuator 1240 that allows the caterpillar assembly 1200 to rotate about a steering axis LA. The steering actuator 1240 enables the toe angle of the caterpillar assembly 1200 to be changed on the runway 2000, but this is not shown in FIGS. 1A to 1C. Examples of the steering actuators 1240 can be electric, hydraulic and/or pneumatic rotary motors. The steering axis LA extends substantially perpendicular to the underbody 1110 of the load assembly 1100 and pierces the caterpillar assembly 1200 in the front end area 1201. It should be noted that the steering axis LA and the inclination axis NA in the front end area 1201 intersect. Thus, when the caterpillar assembly 1200 is in the inclined position in which the reduced footprint A′ is located at the front end portion 1201 of the caterpillar assembly, the steering axis LA also intersects the footprint surface A′ and the caterpillar assembly 1200 can be rotated about the steering axis LA, without causing a gyroscopic movement of the tracked vehicle 1000 relative to the runway 2000.

In addition, the caterpillar ship 1200 includes clamping means. The clamping means comprise a clamping actuator 1250, which enables the caterpillar assembly 1200 to be shifted along a clamping axis KA, which extends substantially in the longitudinal direction of the vehicle. Examples of the clamping actuators 1250 can be electrically, pneumatically and/or hydraulically driven linear guides. In the embodiment in which the tracked vehicle 1000 comprises four caterpillar assemblies 1200, the distance between those caterpillar assemblies 1200 which are opposite one another in the longitudinal direction of the vehicle, ie arranged one behind the other, can be changed with the aid of the clamping actuators 1250. For example, this is necessary for motion along vertical running rail arrangements, which are described in detail below. By shifting the caterpillar assemblies 1200 in the direction of the vertically running rails with the help of the clamping actuators 1250, a clamping force can be generated between the tracked vehicle 1000 and the running rail arrangement in interaction with the rails, which ensures a secure hold of the drive tracks 1210 when driving on the vertically arranged rails and thus preventing slipping.

Due to the large number of degrees of freedom of movement made possible by the drive tracks 1210, the tilting actuators 1220, the shifting actuators 1230, the steering actuators 1240 and the clamping actuators 1250, the tracked vehicle 1000 according to the embodiment shown in FIGS. 1A, 1B and 1C is agile and can carry out various driving maneuvers and drive trajectories within the level of runway 2000. It should be noted that in addition to the steering actuators 1220, shifting actuators 1230, steering actuators 1240 and clamping actuators 1250 described above, the tilting means, shifting means, steering means and clamping means typically comprise other elements such as wiring or an electronic control unit. In addition, the caterpillar assemblies 1200 of the tracked vehicle 1000 according to the invention allow driving on running rail arrangements in order to drive on several runways at different heights, which is described in detail below.

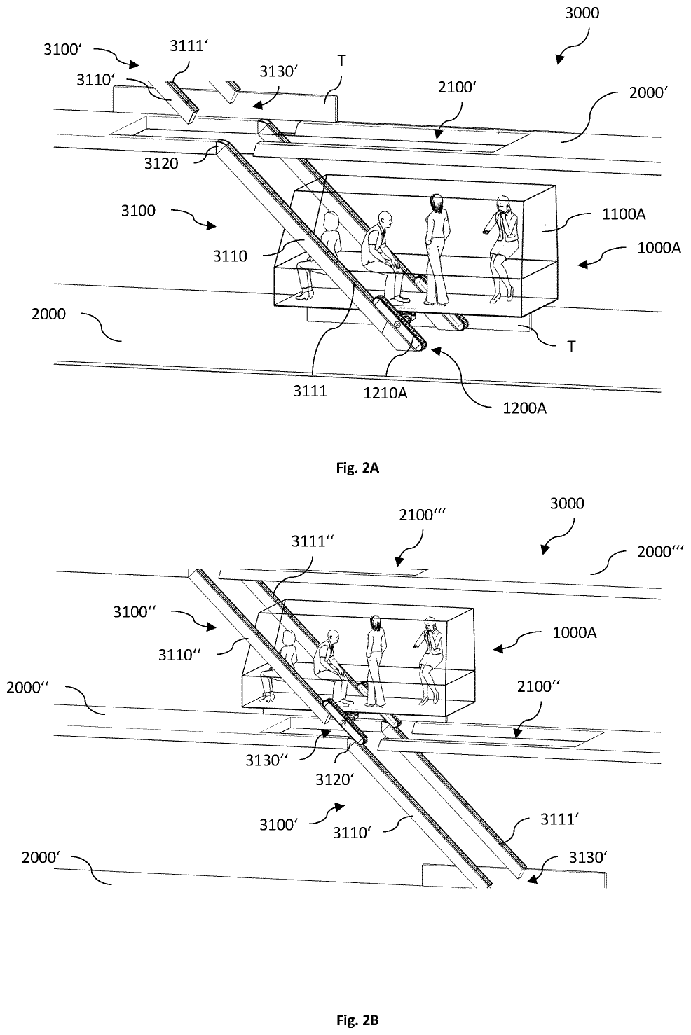

A simple embodiment of such a running rail arrangement 3000 according to the invention is shown in FIGS. 2A and 2B. FIG. 2A shows a schematic perspective view of a tracked vehicle 1000A according to the invention with two caterpillar assemblies 1200A at the beginning of an inclined travel on the running rail arrangement 3000 according to the invention with oblique running modules 3100, 3100′. FIG. 2B shows a schematic perspective view of the tracked vehicle 1000A from FIG. 2A when crossing a passage opening 3130″ between two oblique running modules 3100′, 3100″ during inclined travel.

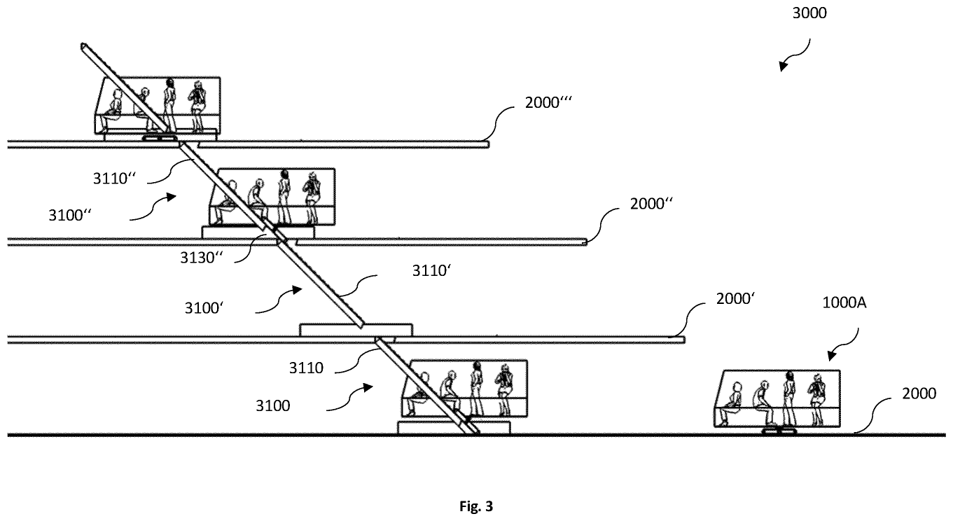

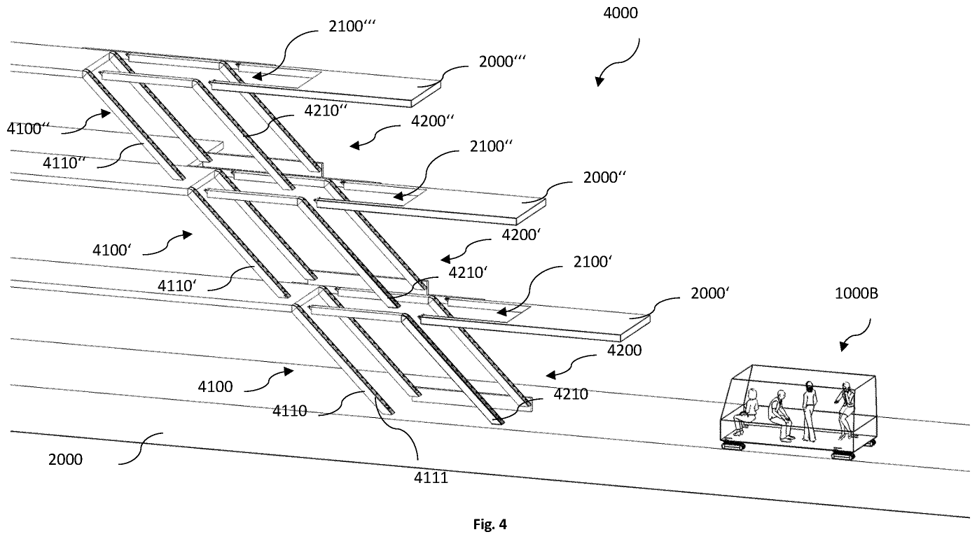

The running rail arrangement 3000 shown in FIG. 2A, FIG. 2B and FIG. 3 comprises oblique running modules 3100, 3100′, 3100″, which connect a lower runway 2000 with a first upper runway 2000′, the first upper runway 2000′ with a second upper runway 2000″ and the second upper runway 2000″ with a third upper runway 2000″. Such a running rail arrangement 3000 can be used, for example, to connect different floors in a building. Other possible uses arise, for example, when connecting different levels in a storage rack system or on steep slopes or mountains.

Each oblique running module 3100, 3100′, 3100″ comprises two running rails 3110, 3110′, 3110″, which run inclined between the runways 2000, 2000′, 2000″, 2000″ and are spaced apart by a distance which corresponds substantially to the distance of the caterpillar assemblies 1200A in the extended position in the vehicle width direction. The running rails 3110, 3110′, 3110″ are attached to a surrounding support structure T and run parallel to one another. On one surface, each running rail 3110, 3110′, 3110″ has a structure 3111, 3111′, 3111″ with projections and depressions, which is designed to form a form-fitting engagement with the structure 1211 of the drive tracks 1210. The running rails 3110, 3110′, 3110″ are positioned relative to one another in such a way that their structures 3111, 3111′, 3111″ are aligned with one another in pairs. A transition element 3120, 3120′, 3120″ is provided at an upper end region of each running rail 3110, 3110′, 3110″, the respective transition element 3120, 3120′, 3120″ connects the running rails 3110 to the first upper runway 2000′, the running rails 3110′ to the second upper runway 2000″ and the running rails 3110″ to the third upper runway 2000″ and also has a projection and depression structure, which is not shown for the sake of clarity. The running rails 3110, 3110′, 3110″ of the oblique running modules 3100, 3100′, 3100″ are not continuously connected to each other, but have passage openings 3130′, 3130″, which interrupt the running rails 3110, 3110′, 3110″ in areas of the runways 2000′, 2000″, 2000″. It should be noted that no passage openings are provided between the lower track 2000 and the running rails 3110 of the oblique running module 3100 in this embodiment, since a continuous connection between the running rails 3110 and the lower track 2000 is required to incline the caterpillar assemblies 1200A.

The running rail arrangement 3000 shown in this embodiment is designed in particular to be driven on by the tracked vehicle 1000A with two caterpillar assemblies 1200A according to the embodiment shown in FIGS. 1A to 1C, which are arranged on two opposite sides of the load assembly 1100A, which is explained below in detail on the basis of FIGS. 2A and 2B detail. FIG. 2A shows the beginning of an inclined travel of the tracked vehicle 1000A along the running rail arrangement 3000. At the beginning of the inclined travel, the tracked vehicle 1000A runs towards the oblique running module 3100 on the lower runway 2000. On the lower runway 2000, the tracked vehicle 1000A can pass between the running rails 3110 through the running rail arrangement 3000 and continue traveling on the lower runway 2000 if the caterpillar assemblies 1200A remain in the retracted position and are not shifted to the extended position. However, to begin the inclined travel along the running rail arrangement 3000, the caterpillar assemblies 1200A are shifted to the extended position. When driving onto the running rails 3110, the caterpillar assemblies 1200A are inclined from a non-inclined horizontal running position about their inclination axis NA in such a way that they are aligned parallel to the inclined running rails 3110, which is referred to as the oblique running position in the following. Due to the distance between the running rails 3110, the load assembly 1100A can be accommodated between the running rails 3110 and does not incline during the entire inclined travel, but remains oriented substantially horizontally. The upper runways 2000′, 2000″, 2000″ also include openings 2100′, 2100″, 2100″, which are dimensioned such that the load assembly 1100A moves when driving on the oblique running modules 3100, 3100′, 3100′ in its non-inclined orientation between the running rails 3110, 3110′, 3110″ without colliding with the second upper runway 2000″. Undesirable shifting of the goods inside or falling of the people inside can thus be prevented when driving on running rail arrangement 3000 even with a steep incline. However, it should be noted that due to the openings 2100′, 2100″, 2100″, as the tracked vehicle 1000A approaches the running rail arrangement 3000 on one of the upper runways 2000′, 2000″, 2000″, the caterpillar assemblies 1200A must be in the extended position in order to prevent the tracked vehicle 1000A from falling into the corresponding opening 2100′, 2100″, 2100″. The structures 1211A with projections and depressions located on the outer surfaces of the drive tracks 1210A engage in the area of the contact surface A with the structures 3111 of the running rails 3110, similar to a gear connection. This creates a form-fitting engagement between the drive tracks 1210A and the running rails 3110, which prevents the drive tracks 1210A from slipping off the running rails 3110 and thus enables safe travel along the running rails 3110.

FIG. 2B shows a situation during the inclined travel of the tracked vehicle 1000A, in which the tracked vehicle 1000A crosses the passage openings 3130″ between the oblique running modules 3100′, 3100″ in order to continue the inclined travel on the running rails 3110″. The passage openings 3130″ are dimensioned in such a way that on the one hand they allow the running rail arrangement 3000 to be left and the second upper runway 2000″ in FIG. 2B to be driven on, which is described below. In addition, the passage openings 3130″ are dimensioned in such a way that it is possible for the caterpillar assemblies 1200A to cross onto the running rails 3110″ of the oblique running module 3100″. In this transition between the running rails 3110′ and the running rails 3110″, the caterpillar assemblies 1200A remain in the oblique running position and are not tilted back to the horizontal running position. This ensures that each drive track 1210A is in uninterrupted contact with at least one of the running rails 3110′, 3110″. As a result, the engagement between the structures 1211A of the drive tracks 1210A and at least one of the structures 3111′, 3111″ of the respective running rails 3110′, 3110″ can be maintained at all times even during the transition between the two oblique running modules 3100′, 3100″ and it is possible to prevent the drive tracks 1210A from slipping off the running rails 3110′, 3110″. It should be noted that the tracked vehicle 1000A can also start the inclined travel from one of the upper runways 2000′, 2000″, 2000″ and, based on this, can safely reach any higher or lower-lying other runway via the running rail arrangement 3000 without that the load assembly 1100A tilts undesirably.

As described above, any number of runways 2000, 2000′, 2000″, 2000″ can be connected to one another at an angle with the oblique running modules 3100, 3100′, 3100″ according to the present invention and can be driven on by the tracked vehicle 1000A according to the invention. In the embodiment shown in FIG. 3, the lower runway 2000 is connected to three upper runways 2000′, 2000″, 2000″. Various positions of the tracked vehicle 1000A are shown during a journey from the lower runway 2000 to the third upper runway 2000″. As shown in a lower right portion of FIG. 3, the tracked vehicle 1000A first runs on the lower runway 2000 and approaches the running rail arrangement 3000 with the caterpillar assemblies 1200A in the horizontal traveling position. Next, similarly as shown in FIG. 2A, the inclined travel is started by shifting the caterpillar assemblies 1200A to the extended position and tilted from the horizontal running position to the oblique running position. At this time, the drive tracks 1210A of the caterpillar assemblies 1200A come into contact with the running rails 3110 of the oblique running module 3100 and engage between the structures 1211A of the drive tracks 1210A and the structures 3111 of the running rails 3110.

As described above, any number of runways 2000, 2000′, 2000″, 2000″ can be connected to one another at an angle with the oblique running modules 3100, 3100′, 3100″ according to the present invention and can be driven on by the tracked vehicle 1000A according to the invention. In the embodiment shown in FIG. 3, the lower runway 2000 is connected to three upper runways 2000′, 2000″, 2000″. Various positions of the tracked vehicle 1000A are shown during a journey from the lower runway 2000 to the third upper runway 2000″. As shown in a lower right area of FIG. 3, the tracked vehicle 1000A first runs on the lower runway 2000 and approaches the running rail arrangement 3000 with caterpillar assemblies 1200A in the horizontal traveling position. Next, similarly as shown in FIG. 2A, the inclined travel is started by shifting the caterpillar assemblies 1200A to the extended position and tilting from the horizontal running position to the oblique running position. At this time, the drive tracks 1210A of the caterpillar assemblies 1200A come into contact with the running rails 3110 of the oblique running module 3100 and engage between the structures 1211A of the drive tracks 1210A and the structures 3111 of the running rails 3110

The next position shown in FIG. 3 shows the tracked vehicle 1000A crossing the passage openings 3130″ at the level of the second upper runway 2000″, similar to that shown in FIG. 2B. The caterpillar assemblies 1200A remain in the oblique running position and are in uninterrupted contact with at least one of the running rails 3110′, 3110″ when crossing the passage openings 3130″. The position of the tracked vehicle 1000A, which is shown in FIG. 3 at the top left, shows the tracked vehicle 1000A after exiting the running rail arrangement 3000 on the third upper runway 2000″, whereas the caterpillar assemblies 1200A being tilted again from the oblique running position to the horizontal running position. In each of the positions of the tracked vehicle 1000A shown in FIG. 3, it is ensured that the load assembly 1100A does not incline undesirably, but remains oriented substantially horizontally. In addition, due to the engagement between the structures 1211A of the drive tracks 1210A and the structures 3111, 3111″, 3111″ of the running rails 3110, 3110′, 3110″, safe inclined travel can be ensured and slipping of the tracked vehicle 1000A can be prevented. It should be noted that the tracked vehicle 1000A, starting from each runway 2000, 2000′, 2000″, 2000′″, can use the running rail arrangement 3000 to move to any other runway 2000, 2000′, 2000″, 2000′ that is located higher or lower. The tracked vehicle 1000A can thus move flexibly in the third dimension between different runways 2000, 2000′, 2000″, 2000′ in addition to a plurality of degrees of freedom of movement within a runway, without the load assembly 1100A tilting undesirably.

In the above embodiments, the simple case was considered that the tracked vehicle 1000A has two caterpillar assemblies 1200A on two opposite sides of the load assembly 1100A in the vehicle width direction and can drive on a running rail arrangement 3000, each with two rails 3110, 3110′, 3110″. According to a further embodiment of the present invention, however, it is also possible to provide four caterpillar assemblies 1200B on the underbody 1110B of the tracked vehicle 1000B according to the embodiment described in FIGS. 1A to 1C. The four caterpillar assemblies 1200B are provided at corner areas of the underbody 1110B of the load assembly 1100B, similar to the arrangement of the wheels of a passenger car.

FIG. 4 shows a schematic perspective view of such a tracked vehicle 1000B according to the invention with four caterpillar assemblies 1200B and a running rail arrangement 4000 according to the invention, which has several runways 2000, 2000′, 2000″, 2000″ connected to each other with oblique running modules 4100, 4200, 4100′, 4200′, 4100″, 4200″.

The oblique running modules 4100, 4200, 4100′, 4200′, 4100″, 4200″ are similar to the oblique running modules 3100, 3100′, 3100″ shown in FIGS. 2A, 2B and 3, which is why a detailed description of similar elements is omitted below. However, as shown in FIG. 4, a first oblique running module 4100 and a second oblique running module 4200 are provided between two runways for the diagonal connection of two runways, for example between the lower runway 2000 and the first upper runway 2000′. Each first oblique running module 4100, 4100′, 4100″ is horizontally spaced from the respective second oblique running module 4200, 4200′, 4200″ by a distance substantially equal to the distance of the inclination axes NA of the caterpillar assemblies 1200B in a straight-ahead position in the vehicle longitudinal direction. In other words, when the tracked vehicle 1000B travels inclined, each of the four caterpillar assemblies 1200B is assigned a running rail 4110, 4210, 4110′, 4210′, 4110″, 4210″. At an upper end area of each running rail 4110, 4210, 4110′, 4210′, 4110″, 4210″ there are transition elements 4120, 4220, 4120′, 4220′, 4120″, 4220″ which connect the running rails 4110, 4210 with the first upper runway 2000′, the running rails 4110′, 4210′ with the second upper runway 2000″ and the running rails 4110″, 4210″ with the third upper runway 2000″ and also have a structure with projections and depressions, which are not shown for reasons of clarity. The running rails 4110, 4110′, 4110″ or the running rails 4210, 4210′, 4210″ are arranged one above the other in such a way that their structures 4111, 4111′, 4111″, 4211, 4211′, 4211″ are aligned in pairs. Passage openings 4130, 4230, 4130′, 4230′, 4130″, 4230″ are provided between each pair of running rails aligned with one another. The passage openings 4130, 4230, 4130′, 4230′, 4130″, 4230″ form a kind of interruption between the running rails, which are aligned in pairs. In addition, the upper runways 2000′, 2000″, 2000″ include openings 2100′, 2100″, 2100″ which are dimensioned such that the load assembly 1100B moves when driving on the oblique running modules 4100, 4100′, 4100″ through it in its non-tilted orientation without colliding with the upper runways 2000′, 2000″, 2000″. In contrast to the running rail arrangement 3000 shown in FIGS. 2A, 2B, 3, in the running rail arrangement 4000 between the lower runway 2000 and the running rails 4110, 4210 of the first oblique running module 4100 and the second oblique running module 4200 passage openings 4130, 4230 are also provided. The caterpillar assemblies 1200B can thus also pass through the passage openings 4130, 4230 on the lower runway 2000 in the extended position.

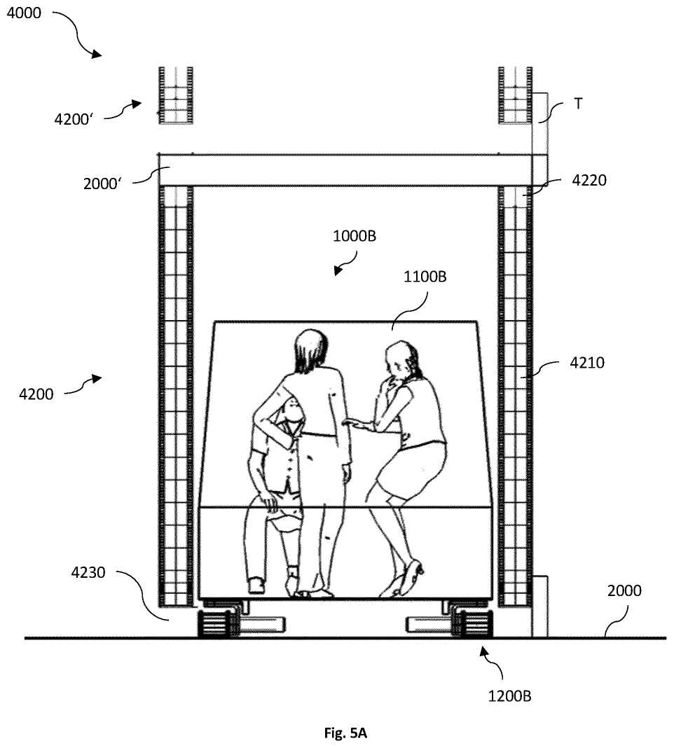

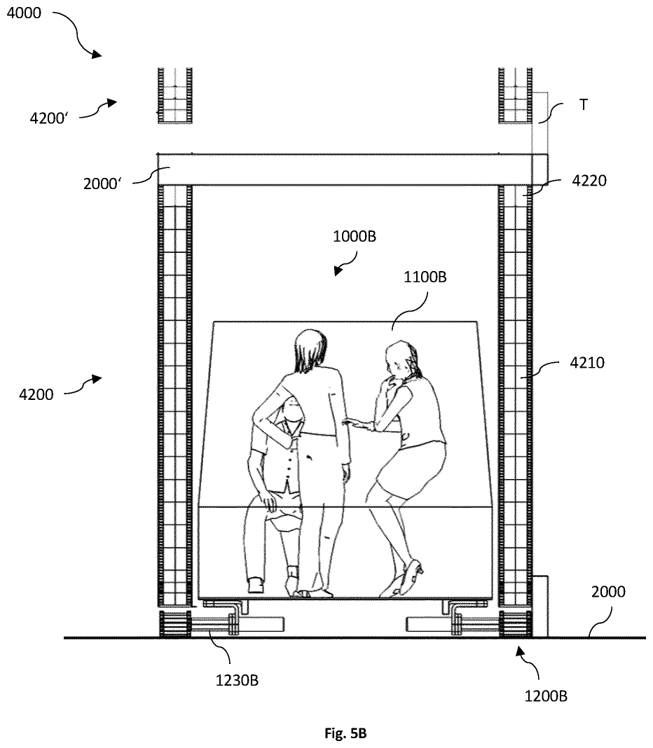

In the FIGS. 5A to 5C different positions of the tracked vehicle 1000B at the start of the inclined travel on the running rail arrangement 4000 are shown when viewed from behind the tracked vehicle 1000B. FIG. 5A shows a schematic view of the tracked vehicle 1000B according to the invention from FIG. 4 when the tracked vehicle 1000B approaches the running rail arrangement 4000 on the lower runway 2000 when viewed from behind. FIG. 5B shows a schematic view of the tracked vehicle 1000B, similar to FIG. 5A, after shifting the caterpillar assemblies 1200B along their inclination axes NA from the retracted position to the extended position, and FIG. 5C shows a schematic view of the tracked vehicle 1000B, similar to FIG. 5A and FIG. 5B, when driving on the running rail arrangement 4000 between an area of the lower runway 2000 and an area of the upper runway 2000′. It should be noted that in FIGS. 5A to 5C only part of the running rail arrangement 4000 is shown, with the following explanations also applying to the area of the running rail arrangement 4000 arranged above it.

When driving into the running rail arrangement 4000, the front two caterpillar assemblies 1200B of the tracked vehicle 1000B, which are in the horizontal running position, first pass through a passage opening 4230 between the lower runway 2000 and the running rails 4210 of the second oblique running module 4200 and approach the running rails 4110 of the first oblique running module 4100. The load assembly 1100B is received between the running rails 4110, 4210 and remains in its horizontal orientation. It should be noted that the caterpillar assemblies 1200B may be in either the retracted position or the extended position when passing through the passage openings 4230 on the lower runway 2000, with the previous case being illustrated in FIG. 5A. However, before the tracked vehicle 1000B can begin the inclined travel on the running rail arrangement 4000, the caterpillar assemblies 1200B are shifted to the extended position with the aid of their shifting actuators 1230B, which is illustrated in FIG. 5B. To drive onto the running rails 4110, 4210, the caterpillar assemblies 1200B are inclined, starting from the non-inclined horizontal running position, about their inclination axis NA in such a way that they are aligned parallel to the inclined running rails 4110, 4210 and are in the oblique running position. Since the tracked vehicle 1000B according to this embodiment comprises four caterpillar assemblies 1200B, the caterpillar assemblies 1200B can be tilted from the horizontal running position to the oblique running position using the tilting actuators 1220B without the load assembly 1100B tilting, even without already engaging with the travel rails 4110, 4210. In the oblique running position, the caterpillar assemblies 1200B continue to approach the running rails 4110, 4210 of the first and second oblique running modules 4100, 4200 until the structures 1211B of the drive tracks 1210B are in form-fitting contact with the structures 4111, 4211 of the running rails 4110, 4210. The subsequent movement of the drive tracks 1210B around the respective caterpillar assemblies 1200B results in movement of the caterpillar assemblies 1200B along the running rails 4110, 4210 and thus in the inclined travel of the tracked vehicle 1000B, which is illustrated in FIG. 5C. The form-fitting engagement between the caterpillar assemblies 1200B and the oblique running modules 4100, 4200 enables the tracked vehicle 1000B to move safely along the running rail arrangement and prevents the drive tracks 1210B from slipping off the running rails 4110, 4210. As shown in FIGS. 5A to 5C, the load assembly 1100B due to the distance between the running rails 4110, 4110′, 4110″ of the first oblique running modules 4100, 4100′, 4100″ and the running rails 4210, 4210′, 4210″ of the second oblique running module is received between the running rails and doesn't tilt during the entire inclined travel. Undesirable shifting of the goods inside or falling of the people inside can thus be prevented even when driving on running rail arrangements with a steep incline.

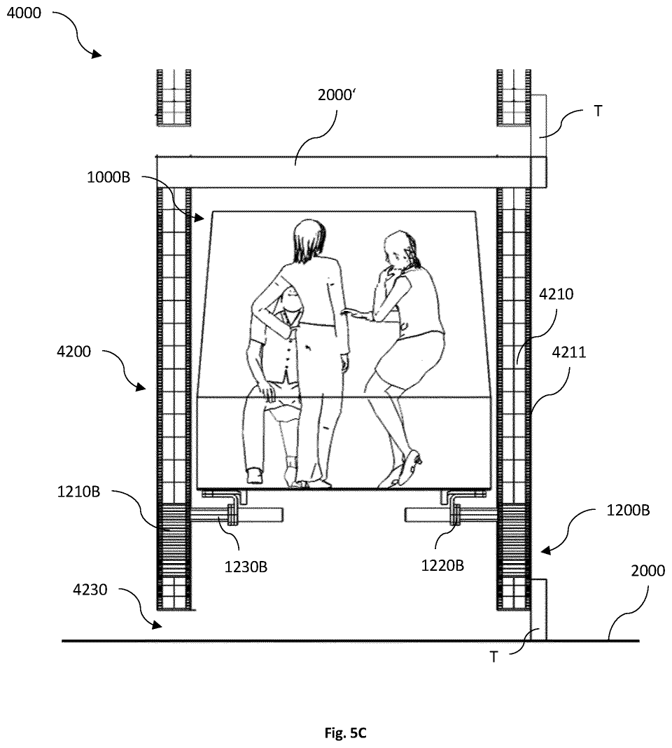

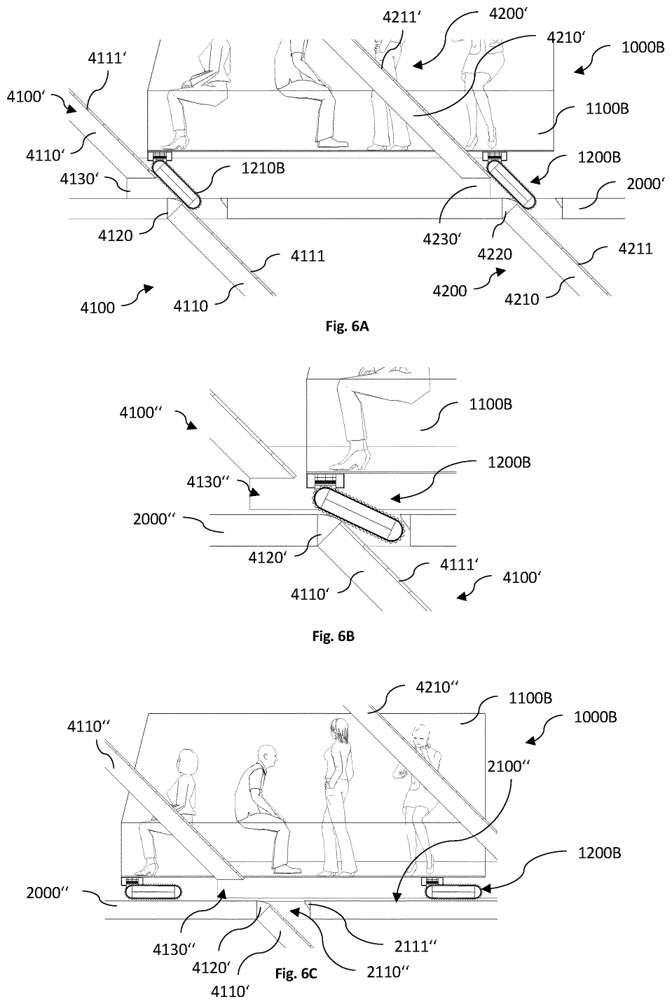

The tracked vehicle 1000B can drive between any runways 2000, 2000′, 2000″, 2000″ with the help of the running rail arrangement 4000. If the tracked vehicle 1000B is to pass a runway during inclined travel, the caterpillar assemblies 1200B must pass through passage openings between two pairs of aligned running rails, which is shown as an example in FIG. 6A. FIG. 6A shows a schematic side view of the tracked vehicle 1000B from FIG. 4 when crossing through passage openings 4130′, 4230′ between oblique running modules 4100, 4200, 4100′, 4200′ during inclined travel.

The tracked vehicle 1000B travels along the running rails 4110, 4210 during the inclined travel, with the structures 1211B of the drive tracks 1210B engaging with the structures 4111, 4211 of the running rails 4110, 4210. However, upon reaching the first upper runway 2000′, the caterpillar assemblies 1200B are not tilted back to the horizontal traveling position and thus remain in the inclined traveling position to continue the inclined traveling. Accordingly, the transition elements 4120, 4220 are not driven on. Instead, the tracked vehicle 1000B continues to travel in the running rail arrangement 4000 and traverses the passage openings 4130′, 4230′ between the oblique running modules 4100, 4200 and the oblique running modules 4100′, 4200′. As shown in FIG. 6A, the passage openings 4130′, 4230′ are dimensioned in such a way that each drive track 1210B, when crossing the passage openings 4130′, 4230′, is always in contact with at least one running rail 4110, 4210, 4110′, 4210′. As a result, the form-fitting engagement of the structure 1211B of each drive track 1210B with the respective structure 4111, 4111′, 4211, 4211′ of the running rails 4110, 4110′, 4210, 4210′ can be maintained at all times and safe inclined travel of the tracked vehicle 1000B can be ensured also when crossing through passage openings 4130′, 4230′. After crossing the passage openings 4130′, 4230′, the tracked vehicle can then continue the inclined travel on the running rails 4110′, 4210′ and continue in the direction of the runway to be reached.

When the tracked vehicle 1000B has reached the desired runway, it moves from the running rail arrangement 4000 onto the runway 2000″ in order to then be able to drive on the runway 2000″, which is shown in FIGS. 6B and 6C. FIG. 6B shows a schematic lateral partial view of the tracked vehicle 1000B, similar to FIG. 6A, when driving over the transition elements 4120′ and the tilting of the caterpillar assemblies 1200B about the respective inclination axis NA into the horizontal running position. FIG. 6C shows a schematic side view of the tracked vehicle 1000B, similar to FIGS. 6A and 6B, when exiting the running rail arrangement 4000 and driving on the upper runway 2000″.

Unlike what is shown in FIG. 6A, the tracked vehicle 1000B in FIGS. 6B and 6C does not cross the passage opening 4130″. Instead, it leaves the running rail arrangement 4000 and drives onto the runway 2000″ to be traveled on. Upon reaching the runway 2000″, the caterpillar assemblies 1200B are inclined about their inclination axes NA from the inclined traveling position to the horizontal traveling position. The caterpillar assemblies 1200B drive on the transition elements 4120′, 4220′, which connect the running rails 4110′, 4210′ to the runway 2000″. In this case, the transition elements 4120′, 4220′ have an arc-like shape and, similar to the running rails 4110′, 4210′, also include a structure with projections and depressions, which is not shown for reasons of clarity. When driving on the transition elements 4120′, 4220′, the structure 1211B of the drive tracks 1210B engages with the structures of the transition elements 4120′, 4220′, which prevents the drive tracks 1210B from slipping off even when driving on the transition elements 4120′, 4220′ and ensures safe exit of the tracked vehicle 1000B from the running rail arrangement 4000.

Immediately after exiting the running rail arrangement 4000, the tracked vehicle 1000B is in a position as shown in FIG. 6C. The caterpillar assemblies are in the horizontal running position and in the extended position and the load assembly 1100B is received between the running rails 4110″, 4210″. In order to fully exit the running rail arrangement 4000, the tracked vehicle 1000B must therefore move a certain distance on the runway 2000″ and the rear two caterpillar assemblies 1200B, which are shown on the right in FIG. 6C, must be horizontal on the runway 2000″ pass through the passage openings 4130″. It should be noted that due to the openings 2100′, 2100″, 2100″, the caterpillar assemblies 1200B must be in the extended position when exiting the running rail arrangement 4000 on one of the upper runways 2000′, 2000″, 2000′ in order to prevent the tracked vehicle 1000B from falling into the corresponding openings 2100′, 2100″, 2100″. Also, the caterpillar assemblies 1200B must traverse an area 2110″ of the opening 2100″ that is adjacent to the transition elements 4120′. In order to prevent the rear two caterpillar assemblies 1200B from unintentionally falling off the runway 2000″ during this crossing, projections 2111″ are provided on the runway 2000″, which decrease the width of the area 2110″ of the opening 2100″ in horizontal direction. The projections 2111″ thereby ensure that the drive tracks 1210B are in contact with the runway 2000″ at all times when traversing the area 2110″ of the opening 2100″ and thus enable the tracked vehicle 1000B to fully exit from the running rail arrangement 4000.

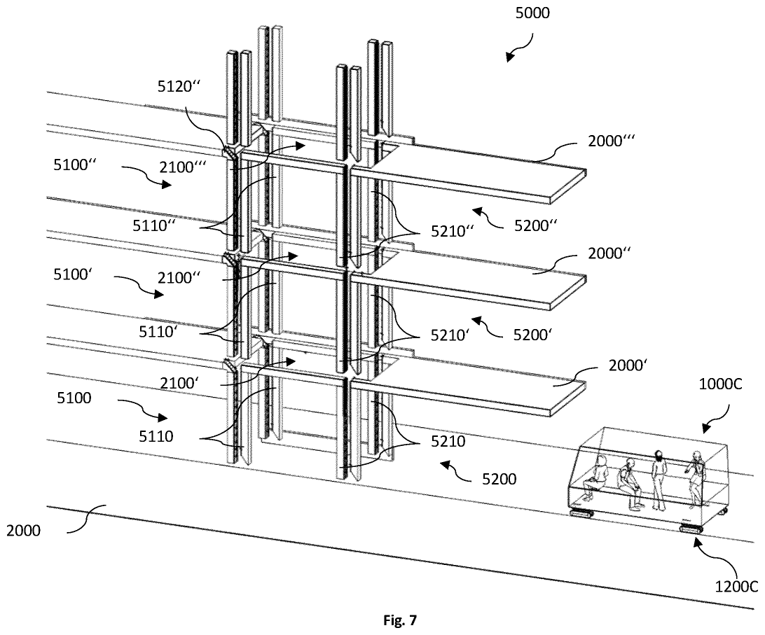

The case considered above was that runways 2000, 2000′, 2000″, 2000″ are connected with oblique running modules 4100, 4200, 4100′, 4200′, 4100″, 4200″. A further embodiment of a running rail arrangement 5000 according to the invention is shown in FIG. 7. FIG. 7 shows a schematic perspective view of a tracked vehicle 1000C according to the invention with four caterpillar assemblies 1200C and the running rail arrangement 5000 according to the invention, which connects several runways 2000, 2000′, 2000″, 2000″ with vertical running modules 5100, 5100′, 5100″. The tracked vehicle 1000C is similar to the tracked vehicle 1000B, but has additional clamping means, which are described in detail below. A detailed description of similar elements of the tracked vehicle 1000C is omitted below.

Each vertical running module 5100, 5100′, 5100″ comprises a first pair of running rails 5110, 5110′, 5110″ and a second pair of running rails 5210, 5210′, 5210″, which are arranged parallel to one another.

The first pair of running rails 5110, 5110′, 5110″ and the second pair of running rails 5210, 5210′, 5210″ are attached to a surrounding support structure T and run vertically between the runways 2000, 2000′, 2000″, 2000″. Examples of the surrounding support structure T can be a building or a storage system. The upper runways 2000′, 2000″, 2000″ include openings 2100′, 2100″, 2100″, which are dimensioned in such a way that the tracked vehicle 1000C moves through it when driving on the vertical running modules 5100, 5100′, 5100″ without colliding with the upper runways 2000′, 2000″, 2000″. Similar to the embodiment of the running rail arrangement 4000 illustrated in FIG. 4, the rails of the first pair of running rails 5110, 5110′, 5110″ and the rails of the second pair of running rails 5210, 5210′, 5210″ are horizontally spaced a distance apart, which corresponds to the distance of the caterpillar assemblies 1200C in the extended position in the vehicle width direction. The first pair of running rails 5110, 5110′, 5110″ is also spaced apart from the second pair of running rails 5210, 5210′, 5210″ by a distance corresponding to the inclination axis NA distance of the caterpillar assemblies 1200C in the straight running position in the vehicle longitudinal direction. In other words, for driving on the running rail arrangement 5000, a running rail is assigned to each caterpillar assemblies 1200C of the tracked vehicle 1000C. Each running rail comprises a structure 5111, 5211, 5111′, 5211′, 5111″, 5211″ with projections and depressions on one surface. Adjacent to the upper end areas of the running rails 5110, 5110′, 5110″, transition elements 5120, 5120′, 5120″ are provided, which also have structures with projections and depressions, which are not shown for reasons of clarity. In contrast to the running rail arrangement 4000 shown in FIG. 4, however, the transition elements 5120, 5120′, 5120″ are not formed integrally with the running rails 5110, 5110′, 5110″. Instead, the transition elements 5120, 5120′, 5120″ are positioned on the respective runway 2000′, 2000″, 2000′ in such a way that their structures correspond to the structures 5111, 5111′, 5111″ opposite of the running rails 5110, 5110′, 5110″. Between the vertically arranged travel modules 5100, 5200, 5100′, 5200′, 5100″, 5200″, passage openings 5130′, 5130″, 5130′″ are also provided. Passage openings 5130, 5230 are also provided between the lower runway 2000 and the first pair of running rails 5110 and the second pair of running rails 5210, respectively.

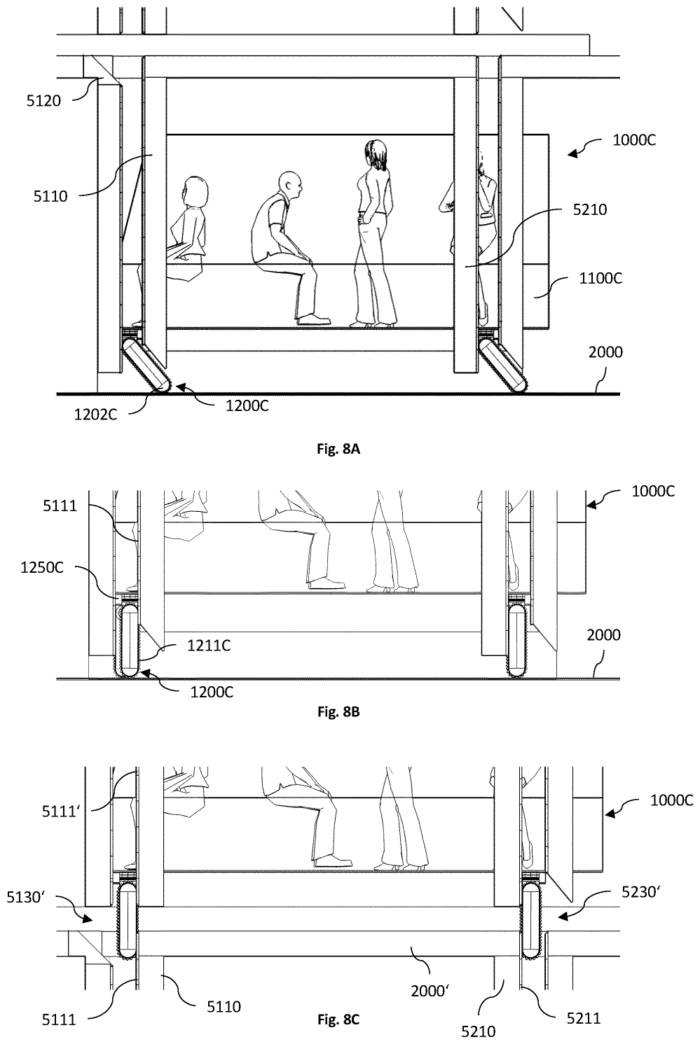

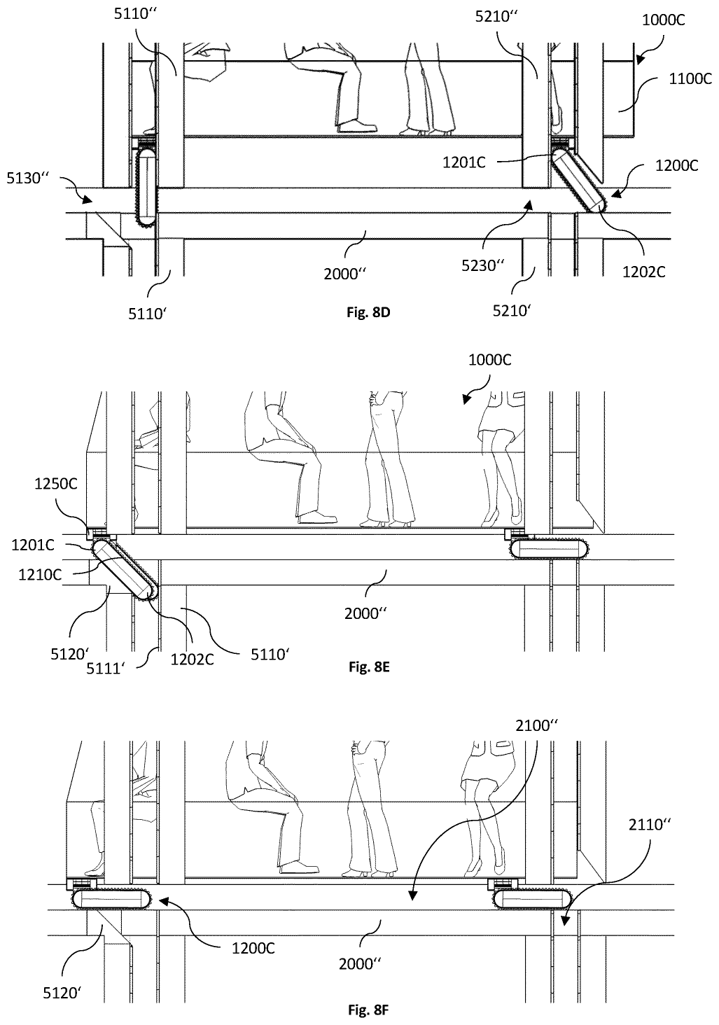

The running rail arrangement 5000 illustrated in this embodiment is designed in particular to be traversed by the tracked vehicle 1000C with four caterpillar assemblies 1200C. Next, various positions and movement sequences of the tracked vehicle 1000C while driving on the running rail arrangement 5000 are described with reference to FIGS. 8A to 8F. As shown in a lower right area of FIG. 7, the tracked vehicle 1000C first runs on the lower runway 2000 and approaches the running rail arrangement 5000 with the caterpillar assemblies 1200C in the horizontal traveling position. The tracked vehicle 1000C enters the running rail arrangement 5000 between the pairs of running rails 5110, 5120 and shifts the caterpillar assemblies 1200C from the retracted position to the extended position. The load assembly 1100C is in this position between the running rails 5110, 5210 and the caterpillar assemblies 1200C are positioned in such a way that they are located below the running rails 5110, 5120 assigned to them, respectively.

In this position, the caterpillar assemblies 1200C are tilted about their inclination axes NA. FIG. 8A shows a schematic side view of the tracked vehicle 1000C from FIG. 7 when the caterpillar assemblies 1200C are tilting about the respective inclination axis NA from the horizontal running position into a vertical running position. In the vertical traveling position, the caterpillar assemblies 1200C are inclined by 90° about their inclination axes NA relative to the horizontal traveling position, and stand up on the lower runway 2000 at a rear end portion 1202C, respectively. As soon as the caterpillar assemblies 1200C are tilted into the vertical running position, the entire load assembly 1100C rises without tilting unintentionally. The caterpillar assemblies 1200C are aligned parallel to the running rails 5110, 5210 and the running rails 5110, 5210 are located between the caterpillar assemblies 1200C which are arranged one behind the other in the longitudinal direction of the tracked vehicle 1000C.

However, in order for the tracked vehicle 1000C to travel vertically along the running rail arrangement 5000, the caterpillar assemblies 1200C must engage the running rails 5110, 5210, as illustrated in FIG. 8B. FIG. 8B shows a schematic side view of the tracked vehicle 1000C, similar to FIG. 8A, when the drive tracks 1210C of the caterpillar assemblies 1200C engage with the structure 5111, 5211 of the respective running rails 5110, 5210. The caterpillar assemblies 1200C in the vertical running position are shifted along their clamping axes KA in the direction of the rails 5110, 5210, whereby a form-fitting and force-fitting engagement between the structure 1211C of the drive tracks 1210C and the structures 5111, 5211 of the running rails 5110, 5210 is produced. As shown in FIG. 8B, it is sufficient if, for example, the two front caterpillar assemblies 1200C (shown on the left in FIG. 8B) are shifted in the direction of the running rails 5110 with the aid of the clamping actuators 1250C, since this also causes the rear two caterpillar assemblies 1200C to be shifted towards the running rails 5210. Due to the shifting of the caterpillar assemblies 1200C, there is a clamping force between the caterpillar assemblies 1200C and the running rails 5110, 5210 on the one hand and a form-fitting engagement between the structure 1211C of the respective drive track 1210C and the structures 5111, 5211 of the running rails 5110, 5210 on the other hand. From this position, safe vertical travel along the running rail arrangement 5000 can be started and the load assembly 1100C can be safely moved in a non-inclined orientation vertically between the runways 2000, 2000′, 2000″, 2000″, preventing the drive tracks 1210C from slipping on the running rails 5110, 5210.

In order for the tracked vehicle 1000C to be able to travel, for example, from the lower runway 2000 to the second upper runway 2000″, it must cross the first upper runway 2000′ during vertical travel, which is illustrated in FIG. 8C. FIG. 8C shows a schematic side view of the tracked vehicle, similar to FIG. 8B, when crossing passage openings 5130′, 5230′ between two vertical running modules 5100, 5100′ arranged one above the other during vertical travel. As described above, the tracked vehicle 1000C runs along the running rails 5110, 5210 during the vertical travel, with the structures 1211C of the drive tracks 1210C engaging with the structures 5111, 5211 of the running travel rails 5110, 5210. On reaching the first upper runway 2000′, however, the tracked vehicle 1000C does not end the vertical journey, but rather crosses the passage openings 5130′, 5230′ between the vertical running modules 5100, 5100′ and the vertical running modules 5200, 5200′. As shown in FIG. 8C, the passage openings 5130′, 5230′ are dimensioned in such a way that each drive track 1210C, when crossing the passage openings 5130′, 5230′, is always in contact with at least one running rail 5110, 5210, 5110′, 5210′. As a result, the clamping force and thus also the engagement between the structure 1211C of each drive track 1210C and the respective structure 5111, 5211, 5111′, 5211′ of the respective running rails 5110, 5210, 5110′, 5210′ can be maintained at all times. After crossing the passage openings 5130′, 5230′, the tracked vehicle 1000C can then continue the vertical journey along the running rails 5110′, 5210′ and continue in the direction of the runway to be reached.

When the tracked vehicle 1000C has reached the designated runway 2000″, the vertical travel along the running rail arrangement 5000 is ended and the journey on the runway 2000″ begins, which is shown in FIGS. 8D to 8F. FIG. 8D shows a schematic side view of the tracked vehicle 1000C, similar to FIG. 8C, when two caterpillar assemblies 1200C arranged next to one another in the vehicle width direction are tilting about the respective inclination axis NA from a vertical running position into a horizontal running position.

In order to begin the exit from the running rail arrangement 5000 onto the upper runway 2000″, the tracked vehicle 1000C first crosses the passage openings 5130″, 5230″ until the rear end areas 1202C of the caterpillar assemblies 1200C are on the same level with the upper runway 2000″. In this position, the tracked vehicle 1000C no longer travels upwards and the caterpillar assemblies 1200C are engaged with the running rails 5110″, 5210″. Subsequently, the rear two caterpillar assemblies 1200C, which are shown on the right in FIG. 8D, are inclined about their inclination axes NA from the vertical running position to the horizontal running position while the tracked vehicle 1000C moves back down towards the upper runway 2000″. First, the rear end portions 1202C of the rear two caterpillar assemblies 1200C come into contact with the upper runway 2000″ while maintaining contact with the running rail 5210″, as shown in FIG. 8D. However, as the rear caterpillar assemblies 1200C incline further into the horizontal running position, the contact at the front end area 1201C with the running rails 5210″ is released and the rear caterpillar assemblies 1200C are only in contact with the upper runway 2000′. During tilting of the rear caterpillar assemblies 1200C, the front caterpillar assemblies 1200C, shown on the left in FIG. 8D, maintain the clamping force and engagement with the running rails 5110′, 5110″. This can ensure that the caterpillar assemblies 1200C of the tracked vehicle 1000C are at all times in contact with a running rail 5110′, 5110″, 5210″ or the upper runway 2000″, and the tracked vehicle 1000C can be prevented from crashing during this sub-step of leaving the running rail arrangement 5000.

Then, the front two caterpillar assemblies 1200C drive on the transition elements 5120′, as shown in FIG. 8E. FIG. 8E shows a schematic side view of the tracked vehicle 1000C, similar to FIG. 8D, during the shifting of at least one caterpillar assembly 1200C by means of its clamping actuator 1250C along the clamping axis KA between the structure 5111′ of the respective running rail 5110′ and the structure of the respective transition element 5120′. The transition elements 5120′ are arranged obliquely on the upper runway 2000″ and adjacent to the upper end regions of the running rails 5110′, with the structures of the transition elements 5120′ facing the structures 5111′ of the corresponding running rails 5110′. In order to pass over the transition elements 5120′, the front caterpillar assemblies 1200C are inclined about their inclination axes NA in such a way that they are aligned parallel to the inclined transition elements 5120′. At this time, as shown in FIG. 8E, the tracked vehicle is moved horizontally to the left. First of all, the contact and thus the clamping force between the rear end regions 1202C of the front caterpillar assemblies 1200C and the structures 5111′ of the running rails 5110′ is maintained. Subsequently, one of the two front caterpillar assemblies 1200C is shifted along its clamping axis KA in such a way that the contact with the corresponding travel rail 5110′ is lost and the caterpillar assembly 1200C comes into contact with the opposite transition element 5120′. Meanwhile, however, the contact between the other front caterpillar assembly 1200C and the running rail 5110′, and the contact between the rear two caterpillar assemblies 1200C and the runway 2000″ is maintained. This process is repeated for the other caterpillar assembly 1200C while the other three caterpillar assemblies 1200C are in contact with either the transition element 5120′ or the upper runway 2000″.

In this configuration, the front two caterpillar assemblies 1200C engage the transition elements 5120′ while the rear two caterpillar assemblies 1200C are already on the upper runway 2000″. It should be noted that for the further travel of the tracked vehicle 1000C after the shifting of the caterpillar assemblies 1200C between the running rails 5110′ and the transition elements 5120′, the rotation direction of the drive tracks 1210C must be reversed in order to avoid wedging of the drive tracks 1210C. As shown on the right of FIG. 8E, the rear caterpillar assemblies 1200C traverse portions 2110″ of the opening 2100″ that are adjacent to an upper end portion of the second pair of running rails 5210′. The areas 2110″ are dimensioned in such a way that they can be crossed by the caterpillar assemblies 1200C in the extended position when exiting the running rail arrangement 5000 without the tracked vehicle 1000C falling off the runway 2000″ as a result.

In order to fully exit the running rail arrangement 5000, the front two caterpillar assemblies 1200C are tilted about their inclination axes NA to the horizontal running position shown in FIG. 8F. FIG. 8F shows a schematic side view of the tracked vehicle 1000C, similar to FIG. 8E, when exiting the running rail arrangement 5000 and driving on the upper runway 2000″. Thus, in the situation illustrated in FIG. 8F, all caterpillar assemblies 1200C of tracked vehicle 1000C are again in the horizontal running position on the upper runway 2000″. The tracked vehicle 1000C can thus start horizontal travel on the upper runway 2000″.

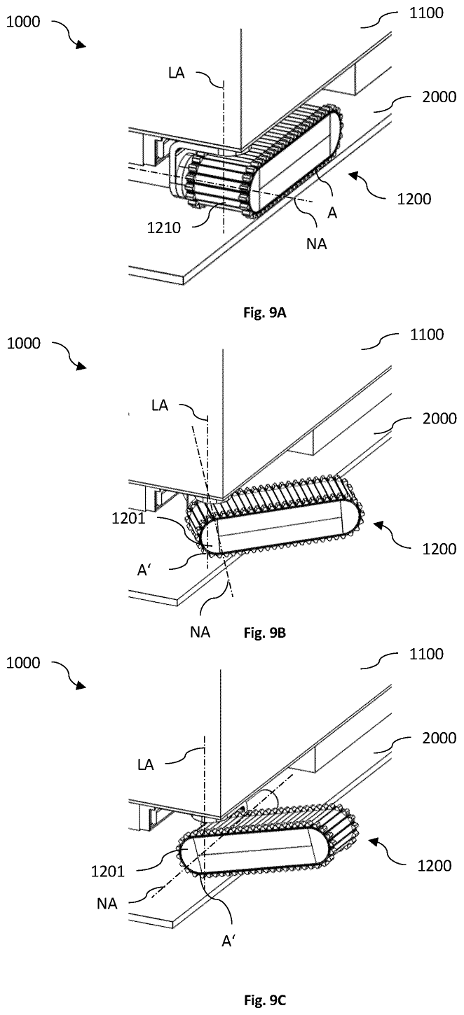

In the above embodiments, the running rail arrangements 3000, 4000, 5000 according to the invention and the driving on them with the tracked vehicles 1000A, 1000B, 1000C according to the invention were described in detail. Further degrees of freedom of movement of the tracked vehicle 1000 according to the invention on the roadway 2000 are described below with reference to FIGS. 9A to 9C. FIG. 9A shows a schematic perspective view of a caterpillar assembly 1200 in the retracted position and in the non-tilted position corresponding to FIG. 1A. In this position, the drive track 1210 of the caterpillar assembly 1200 can be driven and propel the tracked vehicle forward. To change the running direction of the tracked vehicle 1000, the drive tracks 1210 of the caterpillar assemblies 1200 can be driven with different directions of rotation and/or rotational speeds, similar to a snowcat, for example.

On the other hand, the entire caterpillar assemblies 1200 can be turned around their steering axes LA, as shown in FIG. 9B. FIG. 9B shows a schematic perspective view of the caterpillar assembly 1200 from FIG. 9A during a combined rotation about its steering axis LA and tilting about its inclination axis NA. The rotation of the caterpillar assembly 1200 about the steering axis LA leads to a change in the toe angle of the caterpillar assembly 1200. The inclination of the caterpillar assembly 1200 about its inclination axis NA also leads to a shifting of the contact surface A′, which is due to the elongated shape of the caterpillar assembly 1200 smaller than the contact surface A in the non-inclined position. In FIG. 9B, the caterpillar assembly 1200 is thereby inclined in such a way that the contact surface A′ shifts toward the front end region 1201 of the caterpillar assembly 1200, in which the inclination axis NA and the steering axis LA penetrate the caterpillar assembly 1200. Thus, in this position, the contact surface A′ is also penetrated by the steering axis LA. When the caterpillar assembly 1200 rotates around the steering axis LA, the entire tracked vehicle 1000 can be prevented from spinning like a top.

The caterpillar assembly 1200 can be rotated through any angle, such as 90° about the steering axis LA. FIG. 9C shows a schematic perspective view of the caterpillar assembly of FIG. 9A after combined rotation about its steering axis LA and tilting about its inclination axis NA in a transverse running position. In the transverse running position, the caterpillar assemblies 1200 of the tracked vehicle are rotated substantially 90° about their steering axes. In addition, the caterpillar assembly 1200 is inclined such that the footing surface A′ is located at the front end area 1201 of the caterpillar assembly 1200 and is penetrated by the steering axis LA. When all the caterpillar assemblies 1200 of the tracked vehicle 1000 are moved to such a position, the tracked vehicle 1000 runs transversely to the traveling direction shown in FIG. 9A.

The tracked vehicle 1000 can thus change its running direction within a runway 2000 by rotating the caterpillar assembly 1200 about the steering axis LA, preferably with a combined inclination about the inclination axis NA. Thus, for example, a transverse travel of the tracked vehicle 1000 is made possible, wherein the running direction during transverse travel is rotated 90° relative to the running direction illustrated in FIG. 9A. Since the load assembly 1100 does not move when the caterpillar assemblies 1200 rotate about the steering axis LA, little space is required for the direction change of the tracked vehicle 1000 and the agility of the tracked vehicle is ensured even on roadways with little available space.

In the above description of preferred embodiments, the case was considered that the tracked vehicle 1000, 1000A, 1000B, 1000C comprises caterpillar assemblies 1200, 1200A, 1200B, 1200C having an elongated shape with rounded end regions. However, the caterpillar assemblies can also have other shapes and for example have a substantially square, trapezoidal or oval shape.

It was assumed above that the drive tracks 1210, 1210A, 1210B, 1210C are formed with a large number of circulating chain links. However, it is also conceivable that the drive tracks consist of circulating and one-piece belts that have a structure with projections and depressions on their outer surface.

In the above description of vertical travel with reference to FIG. 8B, the case was considered in which the caterpillar assemblies were shifted in relation to one another to generate the clamping force, i.e. in the direction of the center of the tracked vehicle, and the funning rails were located between the caterpillar assemblies in the longitudinal direction of the vehicle during vertical travel. However, it is also possible that the caterpillar assemblies are located between the running rails in the longitudinal direction of the vehicle during vertical travel and the caterpillar assemblies are shifted away from one another in order to generate a tension force between the running rails and the caterpillar assemblies. The tension force then takes the place of the clamping force and ensures an engagement between the structures of the drive tracks and the structures of the running rails. In this configuration, when the runway to be traveled is reached, the front caterpillar assemblies are not shifted along their clamping axes between the running rails and the transition elements, and therefore there is also no reversal of the rotation direction of the front drive tracks, which are shown on the left in FIGS. 8A to 8F. Rather, the conversion and also the reversal of the rotation direction takes place at the rear drive tracks, which are shown on the right in FIGS. 8A to 8F.

The case in which the transition elements are provided adjacent to the upper end regions of the first pair of running rails or the front two running rails was also described in the above description of the vertical travel with reference to FIGS. 8A to 8F. However, it is also possible for the transition elements to be provided adjacent to the upper end regions of the second pair of running rails, i.e. the two rear running rails.

In the above-described embodiments of inclined and vertical travel, the engagement between the drive tracks and the running rails was basically form-fitting and, in the case of vertical travel, additionally force-fitting. According to the present invention, however, it is also possible for the engagement between the drive tracks and the running rails to be of a purely force-fitting nature, as is the case, for example, in DE20 2020 100 256 U1. There is a magnetic force of attraction between the drive tracks, in particular the linear motor, and the running rails.

It should be noted that, in addition to the elements described above, the tracked vehicle according to the invention may comprise one or more electronic control units designed in particular to control the drive tracks, the tilting means, the shifting means, the steering means and the clamping means. The electronic control unit can be provided both physically on the tracked vehicle and also be connected to the tracked vehicle via a wireless connection and thus control the tracked vehicle remotely.

1-20. (canceled)

21. A tracked vehicle defining a width direction, the vehicle comprising:
a load assembly comprising an underbody;
at least two caterpillar assemblies;
at least two drive tracks movably mounted to the load assembly to execute a movement along an orbit of the respective drive track for a travel of the tracked vehicle along a running direction, each of the at least two drive tracks formed at a respective one of the caterpillar assemblies and defining a respective movement direction;
tilting means for tilting the caterpillar assemblies about a respective inclination axis extending substantially perpendicular to the movement direction of the respective drive track; and
shifting means for shifting the caterpillar assemblies along the respective inclination axis between a retracted position and an extended position, wherein:
in the retracted position, the caterpillar assemblies are located below the underbody of the load assembly; and
in the extended position, the caterpillar assemblies overhang the load assembly on opposite sides in the vehicle width direction.

22. The tracked vehicle according to claim 21, which further comprises steering means for changing the running direction of the tracked vehicle.

23. The tracked vehicle according to claim 22, wherein the steering means is adapted to change the running direction of the tracked vehicle by at least one of:
different rotation speeds of the drive tracks; and
different rotation directions of the drive tracks.

24. The tracked vehicle according to claim 22, wherein:
the caterpillar assemblies have respective associated steering axes; and
the steering means is adapted to change the running direction of the tracked vehicle by rotating the caterpillar assemblies about the respective associated steering axes.

25. The tracked vehicle according to claim 24, wherein:
the caterpillar assemblies each have a respective front end portion and a rear end portion; and
in the retracted position, the caterpillar assemblies are pierced by their respective steering axis in one of the front end portion and the rear end portion.

26. The tracked vehicle according to claim 21, wherein:
the caterpillar assemblies each have a respective front end portion and a rear end portion; and
the caterpillar assemblies are pierced by their respective inclination axis in one of the front end portion and the rear end portion.

27. The tracked vehicle according to claim 24, wherein the respective steering axis of each of the caterpillar assemblies intersects a respective inclination axis.

28. The tracked vehicle according to claim 24, further comprising clamping means for shifting at least two of the caterpillar assemblies arranged side by side in the vehicle width direction along respective clamping axes extending substantially in a vehicle longitudinal direction.

29. A running rail configuration, comprising:
at least two running rails disposed substantially parallel to one another, each of the running rails comprising a structure with projections and depressions, the structure adapted to engage in at least one of a form-fitting manner and a force-fitting manner with the at least two drive tracks of the tracked vehicle according to claim 1.

30. The running rail configuration according to claim 29, wherein the structure is provided in the form of a structured surface of a solid running rail.

31. The running rail arrangement according to claim 29, which further comprises:
a lower runway;
a first upper runway;
a surrounding support structure;
at least one oblique running module comprising:
the at least two running rails each having an upper end portion and adapted to be attached to the surrounding support structure such that they extend parallel to one another and obliquely from a lower runway to a first upper runway, the first upper runway being located at a predetermined height relative to the lower runway, and the at least two running rails being horizontally spaced from each other by a distance substantially equal to a distance of the caterpillar assemblies in the extended position in the vehicle width direction; and
at least two arc-shaped transition elements each disposed at the upper end portion of a respective one of the at least two running rails and being adapted to connect the respective running rail to the first upper runway.

32. The running rail arrangement according to claim 31, wherein the tracked vehilde defines a longitudinal direction and which further comprises first and second oblique running modules:
disposed relative to one another such that they each extend obliquely from the lower runway to the first upper runway, the running rails of the first and second oblique running modules being substantially parallel to one another; and
horizontally spaced by a distance substantially equal to a distance of the inclination axes of the caterpillar assemblies in a straight running position in the vehicle longitudinal direction.

33. The running rail arrangement according to claim 31, which further comprises a second upper runway disposed above the first upper runway and wherein:
the at least one oblique running module comprises a plurality of oblique running modules operable to connect the lower runway to the first upper runway and the first upper runway to the second upper runway, the oblique running modules being disposed above each other such that the running rails are aligned in pairs; and
passage openings are defined between the oblique running modules disposed above one another, the passage openings being dimensioned such that:
the caterpillar assemblies are operable to switch between an oblique running position and a horizontal running position for running into or out of the running rail arrangement; and
the caterpillar assemblies in the oblique running position are continuously in contact to at least one oblique running module when crossing the passage openings.

34. A running rail configuration, comprising:
a surrounding support structure;
a lower runway;
a first upper runway;
at least two running rails having upper end portions and being disposed substantially parallel to one another, each of the running rails comprising a structure with projections and depressions, the structure adapted to engage in at least one of a form-fitting manner and a force-fitting manner with the at least two drive tracks of the tracked vehicle according to claim 28; and
at least one vertical running module comprising:
first and second pairs of running rails:
disposed parallel to one another and configured to engage in one of a form-fitting manner and force-fitting manner with the drive tracks of the tracked vehicle; and
being attached to the surrounding support structure such that they extend vertically from the lower runway to the first upper runway, the first upper runway being located at a predetermined height relative to the lower runway;
at least two transition elements configured to be obliquely disposed on the first upper runway at the predetermined height adjacent to the upper end portions of the running rails such that the structure of each of the at least two transition elements is opposite of a structure of a corresponding running rail;
the running rails of each of the first and second pairs of running rails are spaced from each other by a distance substantially equal to a distance of the caterpillar assemblies in the extended position in the vehicle width direction; and
the first pair of running rails being spaced from the second pair of running rails by a distance substantially equal to the distance of the inclination axes of the caterpillar assemblies in the straight running position in the vehicle longitudinal direction.

35. The running rail configuration according to claim 34, wherein the structure is disposed on each of the at least two running rails such that, when the caterpillar assemblies are shifted in a direction of the structure in a vertical running position by the clamping means, one of a clamping force and a tension force is generated between the caterpillar assemblies and the running rails in a horizontal direction.

36. The running rail configuration according to claim 34, which further comprises a second upper runway disposed above the first upper runway such that their respective running rails are aligned in pairs with one another, and wherein:
the at least one vertical running module is a plurality of vertical running modules connecting the lower runway to the first upper runway and the first upper runway to the second upper runway;
the vertical running modules define passage openings therebetween and are disposed one above the other, the passage openings being dimensioned such that the caterpillar assemblies are operable to switch between a vertical running position and a horizontal running position for running into or out of the running rail configuration; and
the caterpillar assemblies are continuously in contact with at least one vertical running module when crossing the passage openings in the vertical running position.

37. A method for running on a running rail configuration according to claim 29 with the tracked vehicle, comprising the following steps:
approaching, of the tracked vehicle, to the running rail configuration on one of a lower runway and an upper runway;
shifting the caterpillar assemblies along a respective inclination axis from a retracted position to an extended position;
tilting the caterpillar assemblies about the respective inclination axis by a predetermined angle from a horizontal running position to one of an oblique running position and a vertical running position;
running into the running rail configuration by engaging the drive tracks of the caterpillar assemblies with the structure of the respective running rails;
running on the running rail configuration between an area of the lower runway and an area of the upper runway;
engaging, of the drive tracks of the caterpillar assemblies, with the structure of the respective transition elements;
running on the transition elements and tilting the caterpillar assemblies about the respective inclination axis into the horizontal running position; and
running out of the running rail configuration and running onto one of the upper runway and the lower runway.

38. The method according to claim 37 for running on the running rail configuration with the tracked vehicle, wherein the step of engaging the drive tracks of the caterpillar assemblies with the structure of the respective transition elements comprises the following sub-steps:
shifting at least one caterpillar assembly by a respective clamping means along the clamping axis between the structure of the respective running rail and the structure of the respective transition element; and
maintaining the engagement of at least three caterpillar assemblies with one of the structures of the respective running rail and the respective transition element.

39. The method according to claim 37, further comprising, after running out of the running rail configuration, a step of shifting the caterpillar assemblies along a respective inclination axis from an extended position to a retracted position.
